(19) United States
(12) Patent Application Publication
(10) Pub. No.: US 2002/0037736 A1
(43) Pub. Date: Mar. 28, 2002

(54) Closed group communication method and communication terminal equipment

(76) Inventors: Kenji Kawaguchi, Yokohama (JP); Susumu Matsui, Machida (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/828,214

(22) Filed: Apr. 9, 2001

(30) Foreign Application Priority Data
Sep. 28, 2000 (JP) 2000-300545

(51) Int. Cl. H04B 7/00; H04Q 7/20

(52) U.S. Cl. 455/518; 455/517; 455/519

(57) ABSTRACT

In a group communication method which autonomously builds up a closed communication network using a large number of unspecified communication terminals, a calling message including group identification information is broadcast to a large number of unspecified communication terminals from an arbitrary communication terminal, a response message including the group identification information is broadcast from other communication terminal, and a closed communication network is formed of the communication terminal and at least one communication terminal which transmits the response message within a given time whereby a group communication is performed by the communication message using the group identification information.

### BACKGROUND OF THE INVENTION

The present invention relates to a closed group communication method and a communication terminal equipment, and more particularly to a group communication method and a communication terminal equipment in a relatively flexible closed communication network built up by undefined or unspecified communication terminals.

A closed communication network is a communication network which can perform a communication only among specified communication terminals which form a group. The closed communication network can be, for example, built up by connecting a plurality of communication terminals using leased lines thus physically ensuring the closed characteristics. Further, the closed communication network may be also constituted such that the user authentication, the terminal equipment authentication, information encryption and the like are used so as to virtually form the communication network into leased lines among the communication terminals of a specific group. In such a closed communication network, by performing a multicasting of information among respective communication terminals, a group communication can be performed.

With respect to a radio communication technique, for example, in Japanese Laid-Open Patent Publication 23028/1998, a method which performs a group communication by building up a closed communication network for an electronic conference system among a plurality of radio terminals is disclosed. According to the invention disclosed in the above-mentioned Laid-Open Patent Publication, an identifier list of terminals which constitute members of the group communication are preliminarily prepared at a specified terminal and when the group communication is started, the specified terminal transmits the identifier list of the member terminals by the same message. Upon receiving the message, each terminal judges whether the identifier of its own terminal is registered in the member identification list or not. If the identifier is registered, the address of its own terminal is informed to the above-mentioned specified terminal. The specified terminal prepares an address list of the member terminals based on the received terminal address and distributes the address list to respective member terminals. Due to such a constitution, each member terminal can obtain the address of all other member terminals so that the group communication among member terminals can be realized.

In the group communication method described in the above-mentioned Laid-Open Patent Publication, it is necessary to preliminarily decide the member terminals which can participate in the group communication and to register the identifiers of the member terminals in the specified communication terminal. Further, in the group communication, it is necessary to call the start of group communication from the specified terminal which is equipped with the identifier list of the member terminals to other member terminals and it is difficult to call the start of the group communication from an arbitrary member terminal.

However, as an application mode of the group communication, for example, there sometimes may be a case in which, to perform the exchange of information for the purpose of an electronic conference or a leisure, the start of the group communication is called from an arbitrary terminal equipment to a large number of unspecified communication terminals present in the field, and a closed communication network is formed between the arbitrary terminal equipment and the terminal equipment which have responded to the calling so that the group communication is carried out quite easily.

### SUMMARY OF THE INVENTION

The present invention provides a group communication method which can autonomously build up a closed communication network among a plurality of unspecified communication terminals. The present invention provides a communication terminal equipment which enables the participation to and the leaving from a closed communication network consisting of a plurality of unspecified communication terminals. Further, there sometimes may be a case in which when a group communication is performed among a plurality of unspecified communication terminals, each terminal autonomously identifies constituting members (communication terminals) of the group so as to build up a flexible communication network.

A group communication method according to one aspect of the present invention includes a step in which a calling message including group identification information is broadcast from a first arbitrary communication terminal to a large number of unspecified communication terminals and a step in which the first communication terminal receives a response message broadcast from other communication terminals and including the group identification information, wherein a closed communication network is formed of the first communication terminal and at least one communication terminal which transmits the response message within a given time after the calling message is transmitted and a group communication is performed by the communication message using the group identification information.

To be more specific, according to the group communication method of the present invention, the first communication terminal stores an address of the transmission terminal of the response message received within a given time after transmitting the calling message as a group constituting terminal corresponding to the group identification information, and transmits a control message indicative of the start of the group communication to the group constituting terminal at a given timing.

A preferred embodiment of the present invention includes a step in which, before transmitting the control message indicative of the start of the group communication, an encryption key to be used in the group communication is informed from the first communication terminal to the group constituting terminal. Further, by setting information indicative of whether the group communication is to be opened or not in the calling message, when the group communication has bee opened, a control procedure for adding a group constituting terminal is performed between the constituting terminal of the closed communication network formed in the initial stage and a newly participating communication terminal so that the size of the closed communication network is flexibly changed.

A communication terminal equipment according to the present invention includes a transmission/reception circuit for transmitting/receiving a communication message, a display device, an input device manipulated by a user, a storage part which stores a connection control program for controlling a transmission/reception of the communication message, and a processor which executes the connection control program, wherein the improvement is characterized in that the processor broadcasts the calling message including group identification information to a large number of unspecified communication terminals in response to an user input from the input device, stores an address of the transmission terminals of the response message including the identification information received by the transmission/reception circuit, forms a group between the communication terminal equipment and the transmission terminal of the response message received within a given time after transmission of the calling message, and performs a control operation such that the group communication is performed using the group identification information.

Other feature of the communication terminal equipment of present invention is that when the communication terminal equipment receives a calling message from other terminal device through the transmission/reception circuit, the processor displays group kind information included in the calling message on the display device and broadcasts a response message including the group identification information in response to the user input from the input device. Due to such a constitution, the communication terminal equipment of the present invention can build up a closed communication network by autonomously identifying constituting terminals of the group among unspecified terminals whereby the group communication can be performed.

These and other benefits are described throughout the present specification. A further understanding of the nature and advantages of the invention may be realized by reference to the remaining portions of the specification and the attached drawings.

### BRIEF DESCRIPTION OF THE DRAWINGS

FIG. 1 shows a sequence at the time of constituting a new closed communication network using a plurality of terminals in the present invention.

FIG. 2 is a constitutional view of a communication terminal equipment according to the first embodiment of the present invention.

FIG. 3 shows one example of a closed communication network constituted by the present invention.

FIG. 4 shows a schematic processing phase in a connection control portion 24 of the communication terminal equipment.

FIG. 5 shows an example of various administration lists formed in a member list portion 25 of the communication terminal equipment.

FIG. 6 shows an example of manipulation keys and display contents provided to a console device of the communication terminal equipment.

FIG. 7 shows a sequence of a keep-alive processing according to the present invention.

FIG. 8 shows a processing sequence when a new terminal is added to an existing closed communication network in the present invention.

FIG. 9 shows a processing sequence when the terminal under the group communication leaves from the closed communication network in the present invention.

FIG. 10 shows formats of communication messages 100-107 used in the embodiment.

FIG. 11 shows formats of communication messages 108-113 used in the embodiment.

FIG. 12 shows a flow chart of a portion of a connection processing routine 100 provided to the connection control portion 24 of the communication terminal.

FIG. 13 shows a flow chart of another portion of the connection processing routine 100.

FIG. 14 shows a flow chart of another portion of the connection processing routine 100.

FIG. 15 shows a flow chart of a keep-alive processing routine 210 provided to the connection control portion 24.

FIG. 16 shows a flow chart of the detail of a keep-alive request processing 230 in the keep-alive processing routine 210.

FIG. 17 shows a flow chart of a connection processing for addition routine 300 provided to the connection control portion 24.

FIG. 18 shows a flow chart of a reception processing routine 400 provided to the connection control portion 24.

FIG. 19 shows a flow chart of a leaving processing routine 500 provided to the connection control portion 24.

FIG. 20 shows a flow chart of a dissolving processing routine 600 provided to the connection control portion 24.

FIG. 21 shows a sequence diagram of another embodiment of the connection processing for addition.

FIG. 22 shows a sequence diagram of another embodiment of the connection processing for addition.

FIG. 23 shows a flow chart of a calling connection processing routine 700 provided to the connection control portion 24.

FIG. 24 shows a flow chart of another embodiment of the reception processing routine 400.

FIG. 25 shows a flow chart of another embodiment of the connection processing for addition routine 300D.

FIG. 26 shows one example of a constitution of a closed communication network to which an Internet terminal can be additionally connected.

### PREFERRED EMBODIMENTS OF THE PRESENT INVENTION

Preferred embodiments of the present invention are explained in detail hereinafter in conjunction with attached drawings.

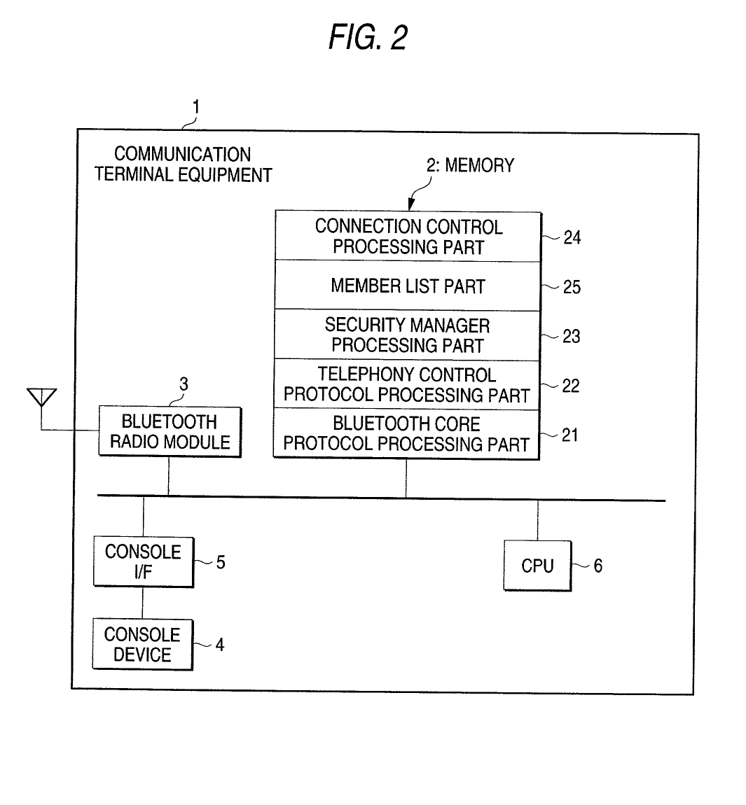

FIG. 2 shows a communication terminal equipment of one embodiment of the present invention which builds up a closed communication network and performs a group communication with other terminals.

A communication terminal equipment 1 is, for example, a radio terminal which satisfies the Bluetooth specification which has a relatively short communication distance of approximately several tens meters.

A radio terminal 1 includes a memory 2 which stores control information and a control program, a transmission/reception circuit (Bluetooth Radio module) 3 for performing a radio modulation and demodulation of transmission/reception data, a console device 4, a console interface part 5 and a processor (CPU) 6.

The memory 2 includes, as software for control, a Bluetooth core protocol processing portion 21 which performs a transmission/reception control, a Telephony Control protocol processing portion 22 which performs a calling control by setting a communication connection, and security manager processing portion 23 which has functions of identification of terminals (Authentication) and approval of services (Authorization).

The above functions are disclosed in Baseband Specification, Link Manager Protocol, Logical Link Control, Adaptation Protocol Specification, and Telephony Control protocol Specification of “Specification of the Bluetooth System -CORE-”, Bluetooth SIG, Inc, the entire contents of which are incorporated herein by reference for all purposes. The security manager processing portion 23 is also disclosed in “Bluetooth Security Architecture” (July'99, Nokia Mobile Phones, http://www.bluetooth.com), the entire contents of which are incorporated herein by reference for all purposes.

In the radio terminal 1 of the present invention, the memory 2 further includes a connection control processing portion 24 for forming a closed communication network for group communication (hereinafter called “CUG (Closed Users Group)” among a plurality of arbitrary communication terminals and a member list portion 25 for storing administration information on the CUG constituting terminals.

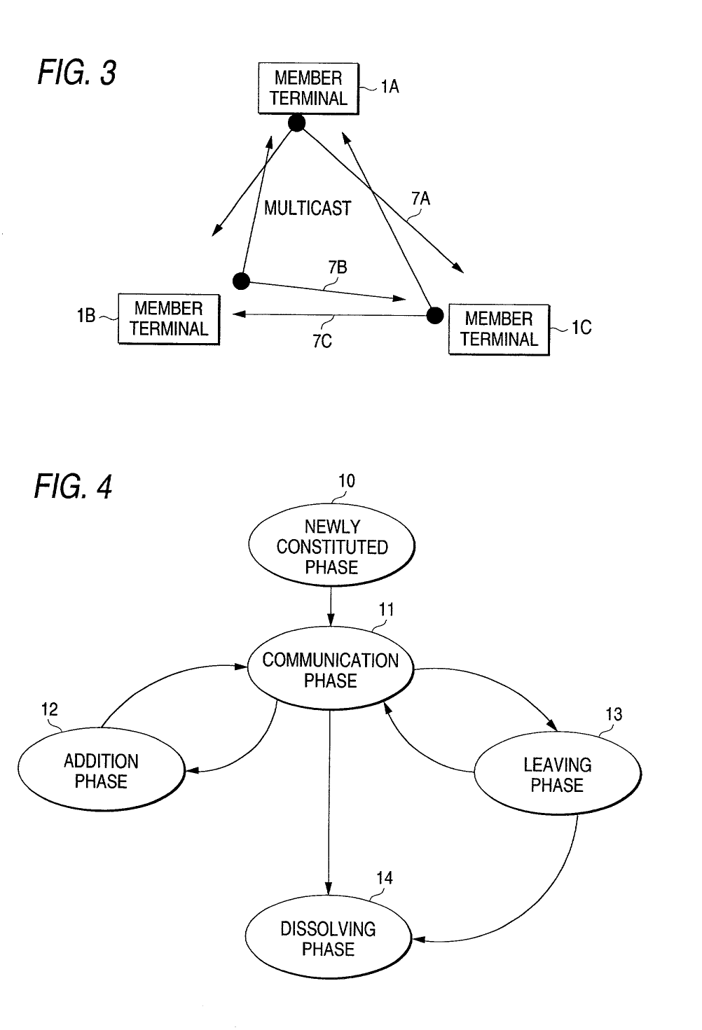

FIG. 3 shows a closed communication network (CUG) made of a plurality of radio terminals 1 (1A, 1B, 1C, . . . ) constituted by the present invention. Each radio terminal 1 prepares a communication message which adds control information such as a kind of message, destination terminal address, group identifiers to user information and transmits the communication message through channels for broadcasting. Upon receiving the transmitted message from other terminal through the broadcasting channel, each radio terminal judges whether the received message is a message directed to the own terminal or not based on the control information such as the kind of message, the destination terminal address, the group identifiers and takes in the message directed to the own terminal and discards other messages.

That is, according to the present invention, each radio terminal 1 which constitutes the CUG transmits the message to which the message kind which indicates that the data is the group communication data and the group identifier of the CUG are added, and only the CUG constituting terminal takes in the message so that a multicast communication 7 (7A, 7B, 7C. . . . ) of the messages among the CUG constituting terminals can be realized. Here, each radio terminal encrypts a specified information portion of the transmitted message, for example, the user information and the specified control information using an intrinsic encryption key for every CUG, and distributes a decryption key of the encrypted information only to the CUG constituting terminal so that the group communication having the high closed characteristics which can prevent the interception of the message by the terminals other than CUG constituting terminal can be realized.

FIG. 4 shows a schematic processing phase in the connection control processing portion 24. A new connection phase 10 is a phase for making the radio terminal 1 subscribe for the closed communication network (CUG). In this phase, the control operation for building up a new CUG based on the calling from the radio terminal 1 to other unspecified radio terminals or the participation to an existing CUG based on the participation request from the radio terminal 1 is executed.

A communication phase 11 is a phase for making the radio terminal 1 perform the closed group communication. In an embodiment which will be explained later, each CUG constituting terminal transmits an encrypted message in a multicast manner in a communication phase 11. Further, to increase the confidentiality, an encryption key is changed at a random timing (keep-alive processing).

An addition phase 12 is a phase for adding other radio terminal to a CUG to which an own terminal belongs. This addition phase 12 is executed when each terminal under the operation in the communication phase 11 receives a participation request to the CUG to which the own terminal subscribes from a new terminal or when a calling to the CUG from the new terminal to the other terminal is made and a participation response is received from the new terminal.

A leaving phase 13 is a phase in which when any one of terminals leaves a CUG, the leaving phase 13 deletes administration information on the leaving terminal from the member list portion 25 of the CUG. Each terminal constituting the CUG regards not only the radio terminal which transmits the leaving communication by itself but also the radio terminal which does not send a response to a calling of change of an encryption key (keep-alive request) as the leaving terminal and deletes administration information from the member list portion 25 of the CUG.

A dissolving phase 14 is a phase in which when the own terminal is left from the CUG, administration information on the left CUG is deleted from the member list portion 25 of the CUG. When the own terminal leaves from the CUG, each radio terminal 1 transmits a leaving communication to other terminals constituting the corresponding CUG and the administration information on the CUG is deleted from the member list portion 25. When administration data on other leaving terminal is deleted from the member list portion 25 in the previously-mentioned leaving phase 13 so that only the own terminal becomes the subscribing terminal of the CUG, CUG is also dissolved.

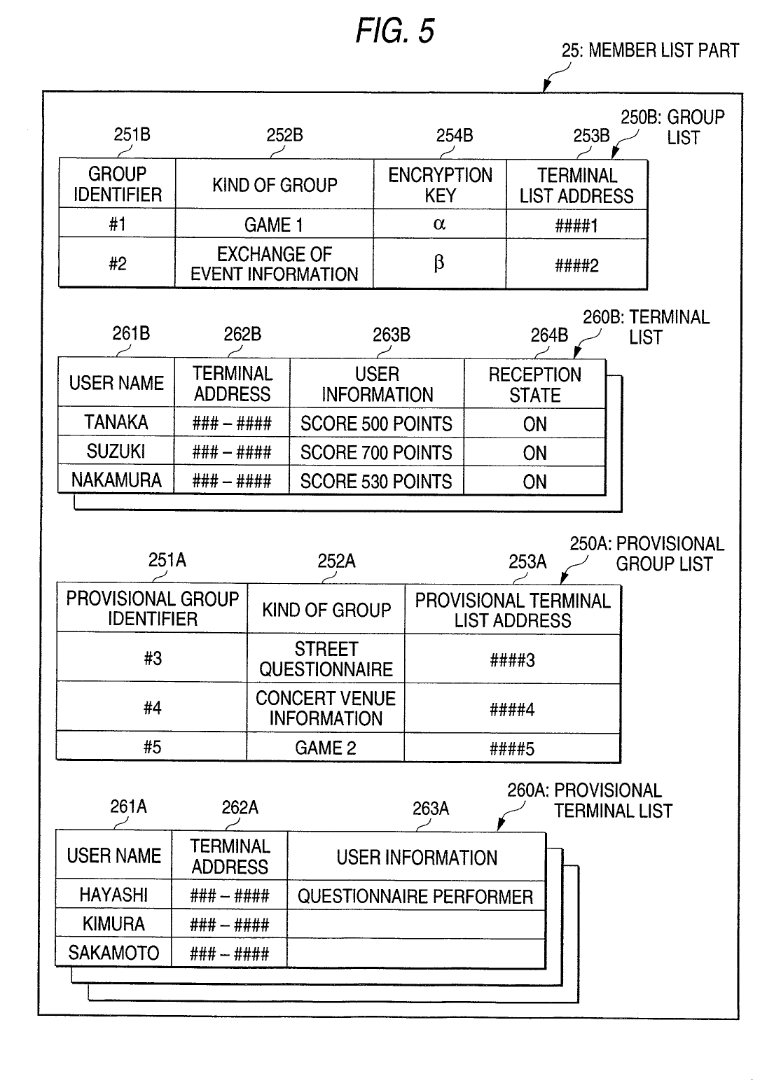

FIG. 5 shows an example of various administration lists formed in the member list portion 25. In the member list portion 25, for example, four administration lists consisting of a provisional group list 250A, a provisional terminal list 260A, a group list 250B and a terminal list 260B are formed. The provisional group list 250A indicates administration information on the CUG which is being newly formed and the provisional terminal list 260A indicates administration information on the CUG constituting terminals registered in the provisional group list 250A, that is, the radio terminal which calls for the forming of the CUG and the radio terminals which express their subscription to the CUG.

The connection control processing portion 24 of each radio terminal 1 monitors a calling message for forming a new CUG which other terminal delivers and a response message to replay this calling message delivered from other terminal. When the radio terminal 1 receives the calling message for forming the new CUG from other terminal, an administration information entry on the new CUG is registered in the provisional group list 250A. Each entry of the provisional group list 250A consists of, for example, a group identifier of the newly generated CUG (hereinafter called “provisional group identifier”) 251A, a group kind 252A of the CUG and a pointer address 253A of the provisional terminal list 260A which corresponds to the CUG. As the group kind 252A, for example, a communication purpose in the CUG, the name of the representative of the CUG or the like is used.

In the provisional terminal list 260A, as the administration information of the CUG constituting terminal, a user name 261A and a terminal address 262A extracted from the calling message for forming the CUG and a user name 261A and a terminal address 262A extracted from a response message to the calling are registered. Further, in each entry, information which shows the attribute of each member is registered as the user information 263A. The content of the provisional group list 250A is displayed on a console screen at a point of time that the calling message is received or in response to a request from the user. When the user specifies any one of entries from the displayed provisional group list 250A, the content of the provisional terminal list 260A corresponding to the specified entry is displayed on the console screen.

The group list 250B indicates administration information on the CUG for which the user (radio terminal 1) performs the subscription procedure and the terminal list 260B indicates administration information on each constituting terminal of the CUG registered in the group list 250B. Each entry of the group list 250B includes a group identifier 251B of the CUG, a group kind 252B of the CUG, an encryption key 254B used in the CUG, and a pointer address 253B of the terminal list 260B corresponding to the CUG. Each entry of the terminal list 260B includes a user name 261A of each terminal constituting the CUG, a terminal address 262B, user information 263B and a reception state 264B from each terminal. In the reception state 264B, ON is registered when a keep-alive request (calling of change of the encryption key) which will be explained later or a response to the keep-alive request is received from the corresponding terminal.

With respect to the CUG to which each radio terminal 1 subscribes, by registering the terminal address registered in the terminal list 260B in the security manager processing portion 23 as the connection permission terminal, a connection is established when a setting request of a P-P (Point-to-Point) connection is received from the corresponding terminal.

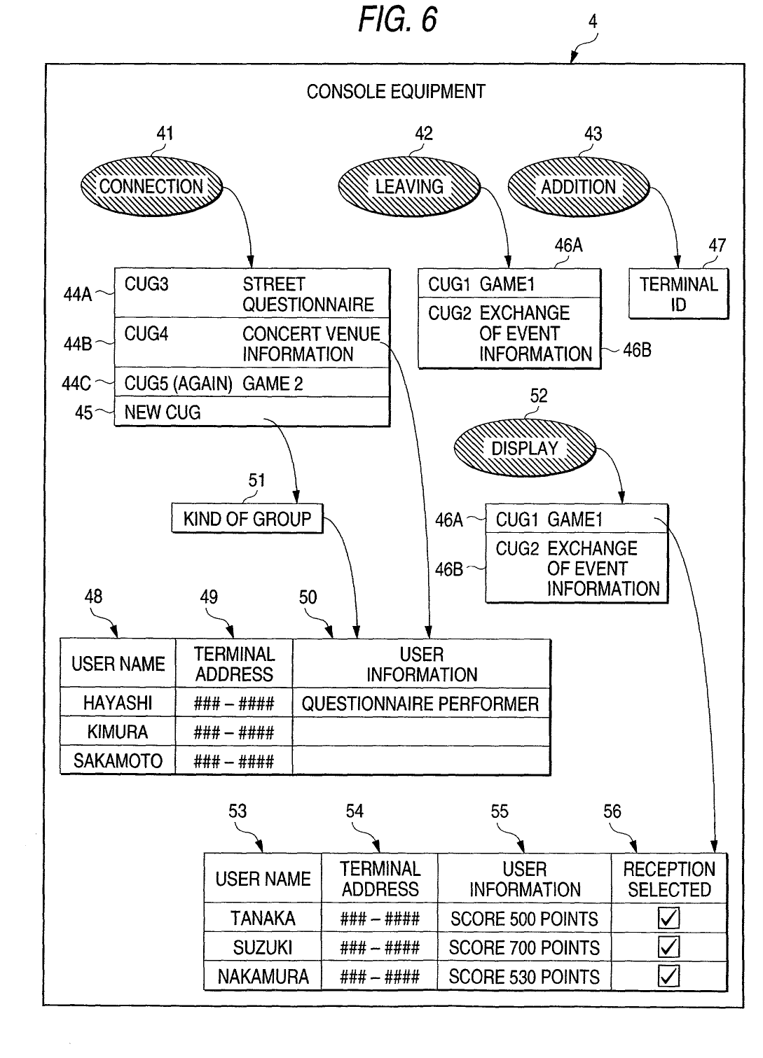

FIG. 6 shows the relationship between CUG control keys prepared in the console device 4 of a mobile terminal 1 and a display content. The console device 4 includes a connection input key 41, a dissolving input key 42, an addition input key 43, and a display key 52 as the CUG control keys. These control keys may be prepared in an icon form displayed on a console screen. The connection input key 41 is provided for making the connection control processing portion 24 start the processing of the new connection phase 10. When the connection input key 41 is selected, on the console device 4, a menu screen including CUG alternatives 44 (44A, 44B, 44C . . . ) showing the contents of group identifiers 251A and the kinds of group 252B and the CUG alternatives 45 of the new CUG registered in the provisional group list 250A are displayed.

When the user selects any one of the CUG alternatives 44, a member list which respectively indicates the terminal user name 261A, the terminal address 262A and the user information 263A registered in the provisional terminal list 260A of the selected CUG as a terminal user name 48, a terminal address 49 and a user information 50 registered in the provisional terminal list 260A are displayed on the console screen. In such a state, when the user selects the connection input key 41, the connection processing is executed to the selected CUG. When the user selects the alternative 45 of the new CUG, a group kind input box 51 is displayed and an input of the group kind is accepted from the user. When the user selects the connection input key 41 after inputting the group kind, the new CUG forming processing is executed and a message calling for the participation to the new CUG is transmitted in a multicast manner. Each time the response message to the calling from other terminal is received, the terminal user name 48, the terminal address 49 and the user information 50 of the radio terminal which expresses the will to participate in the new CUG (that is, the radio terminal registered in the provisional terminal list 260A corresponding to CUG) are displayed.

The leaving input key 42 is an input key for making the connection control processing portion 24 start the processing of the dissolving phase 14. When the leaving input key 42 is inputted, on the console device 4, a menu screen including CUG alternatives 46 (46A, 46B, . . . ) showing the content of a group identifier 251B and a group kind 252B of the CUG registered in the group list 250B, that is, the CUG in which the radio terminal 1 currently participates is displayed on the console device 4. When the user selects any one of the alternatives in the menu, a message which informs the leaving of the own terminal is transmitted to the constituting terminals of the selected CUG in a multicast manner and the entry on the leaving CUG is deleted from the group list 250B. Along with this deletion of the entry, the terminal list 260B corresponding to the leaving CUG is cancelled from the member list portion 25.

The addition input key 43 is an input key for making the connection control processing portion 24 start the addition phase 12 or the new connection phase 11. When the inputting by the addition input key 43 is performed, a terminal address input box 47 for specifying a counterpart terminal which requests the connection to the same CUG is displayed on the console device 4. When the user inputs the terminal address into the above-mentioned terminal address input box 47, a message which requests the connection to the same CUG as the own terminal is transmitted to the radio terminal having the above-mentioned address.

The display key 52 is an input key for displaying administration information on the CUG which the radio terminal 1 currently participates in or belongs to. When the input is made by the display key 52, a menu screen appears on the console device 4 and the alternatives 46 (46A, 46B, . . . ) indicating contents of the group identifier 251B and the group kind 252B registered in the group list 250B are displayed. When the user selects any one of the alternatives 46 in the menu, the contents of the terminal user name 261B, the terminal address 262B, the use information 263B, the reception selection field 264B registered in the terminal list 260B corresponding to the above-mentioned selected CUG are displayed respectively as a terminal user name 53, a terminal address 54, user information 55 and a reception selection field 56 on the console device 4. The reception selection field 56 is a field for designating whether a received message from each constituting terminal of the CUG is to be taken in or not and usually a check mark is set as a default value. If the user wants to abandon the received message with respect to a specified terminal, the user may cancel the check mark affixed to the reception selection field 56 of the above-mentioned specified terminal. When the check mark is cancelled, a reception state field 264B of the terminal list 260B corresponding to the check mark becomes an OFF state.

Each time the radio terminal 1 receives the user message, the radio terminal refers to the above-mentioned terminal list 260B. When the reception state field 264B of the entry corresponding to the transmission terminal address of the received message becomes an OFF state, the received message is subjected to the abandoning processing. However, among the received messages from the terminal with the reception state field 264B held in the OFF state, the messages which are abandoned are limited only to the messages including usual user information and messages for controlling are not abandoned.

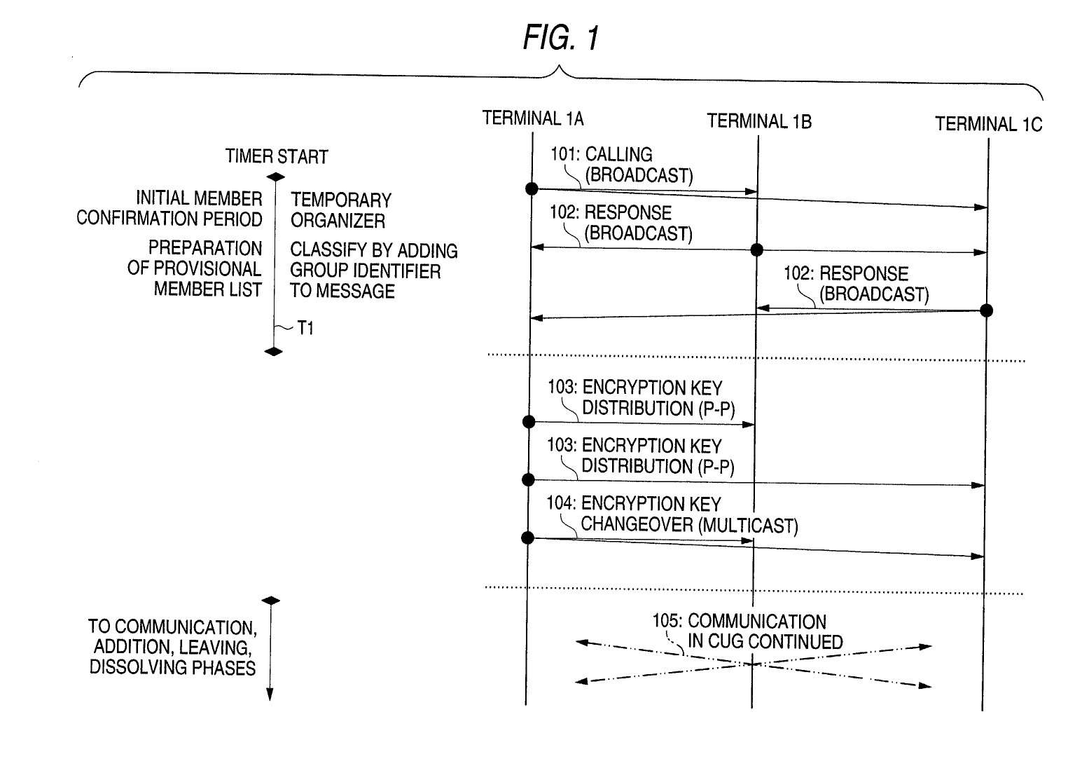

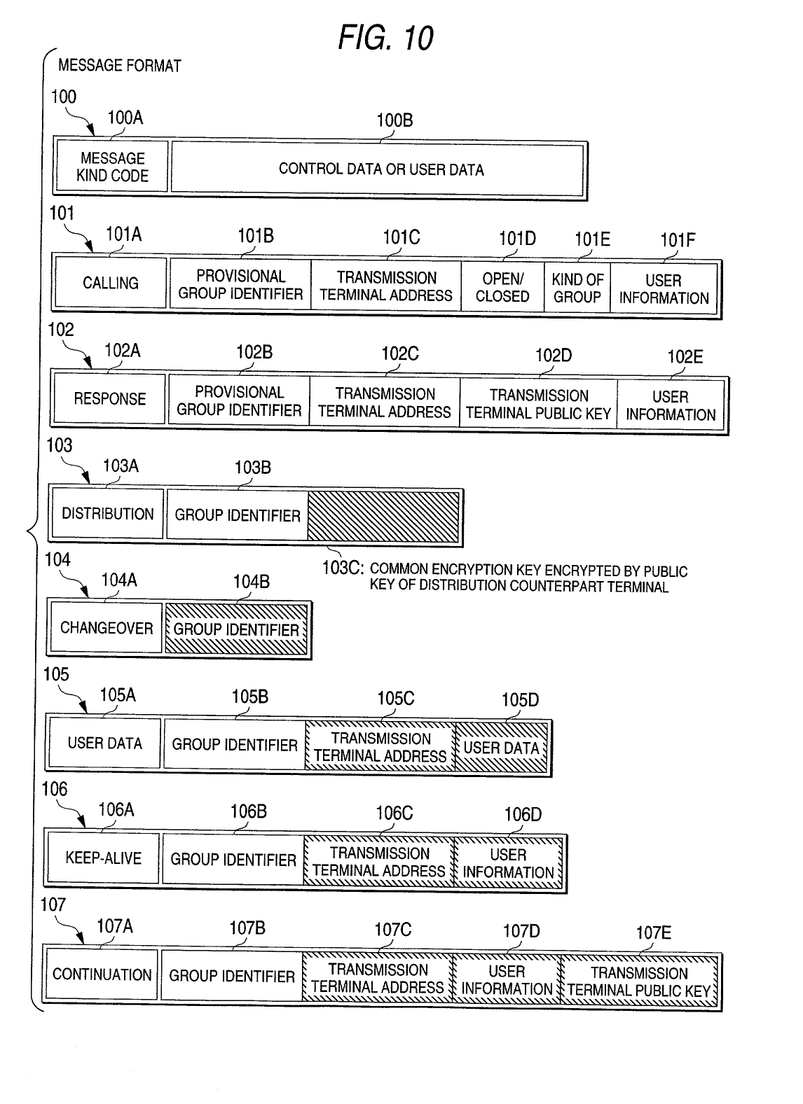

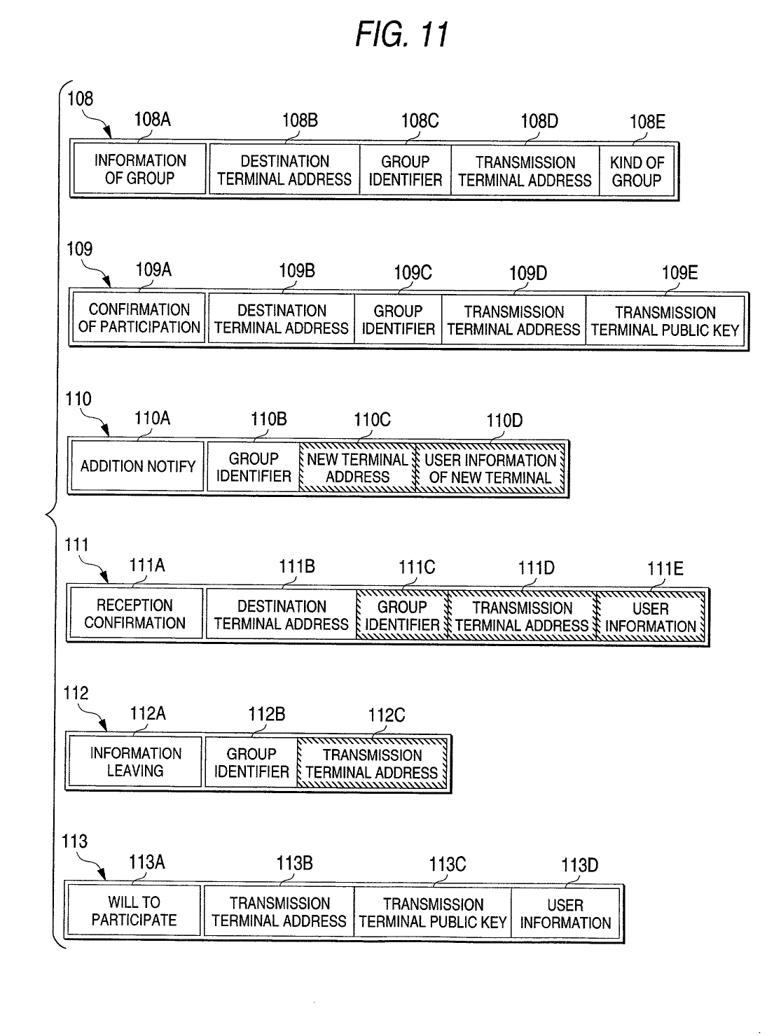

FIG. 1 and FIG. 7-FIG. 9 show the processing sequence for a group communication executed by each radio terminal 1 and FIG. 10 and FIG. 11 indicate formats of various messages used in the group communication of the present invention, wherein hatching portions indicate information portions to be encrypted. As indicated by a message 100, each message includes a message kind code portion 100A indicating the message kind and a data portion 100B containing control data and user data.

FIG. 1 shows the processing sequence in which the radio terminal 1 forms a new CUG as a caller and builds up the closed communication network. This processing sequence is executed in the previously mentioned new connection phase 10. When the connection input key 41 is selected in the console device 4 and the new CUG alternatives 45 are selected in the selection menu, the radio terminal 1A generates a provisional group identifier 251A and requests the user to set the group kind 252A and registers a new CUG administration information entry including the above-mentioned identifier and the group kind to the provisional group list 250A. Thereafter, the radio terminal 1A generates and broadcasts a calling message 101 for calling a large number of unspecified radio terminals to participate in the above-mentioned CUG.

As shown in FIG. 10, the above-mentioned calling message 101 includes a message kind code 101A indicative of the calling, a provisional group identifier 101B, a transmission terminal address 101C, an open/closed flag 101D indicating the direction whether the CUG is to be open to other radio terminals other than members (constituting terminals) of the initial state, a group kind 101E and user information 101F including a user name of the transmission terminal and the like or not. When the radio terminal adopts the Bluetooth specification, it may be possible to use a MAC address allocated to each terminal as the above-mentioned transmission terminal address 101C. Further, as the above-mentioned provisional group identifier 101B, the address of the radio terminal 1A which becomes the transmission source may be used.

After transmitting the calling message 101, the radio terminal 1A starts a timer A and waits for a response from other radio terminal for a preset initial member confirmation period (T1).

Each radio terminal has a function of monitoring the calling message 101 and the response message corresponding to this calling message 101 and a function of registering the newly entry to the provisional group list 250A and the provisional terminal list 260A at the time of receiving these messages.

When the radio terminals 1B, 1C receive the above-mentioned calling message 101, these terminals 1B, 1C register the new entry corresponding to the CUG indicated by the calling message to the provisional group lists 250A and the provisional terminal lists 260A. In the registration entry of the provisional group list 250A, the provisional group identifier 101B and the group kind 101E extracted from the calling message 101 are set. Further, in the registration entry of the provisional terminal list 260A, the terminal address 101C extracted from the calling message 101 and the user name indicated by the transmission terminal user information 101F are set. Upon receiving the above-mentioned calling message 101, the radio terminals 1B, 1C informs the user of the generation of the new CUG through the console screen and wait for a response input from the user.

In the radio terminals 1B, 1C, when the user selects the connection input key 41 and selects the entry of the above-mentioned CUG among the menu displayed on the console screen, the content of the administration information entry of the selected CUG in the provisional group list 250A and the content of the provisional terminal list 260A corresponding to the administration information entry are respectively moved to the group list 250B and the terminal list 260B and thereafter the response message 102 is broadcast. As shown in FIG. 10, the response message 102 includes a message kind code 102A indicative of the response, a provisional group identifier 102B, a transmission terminal address 102C, a transmission terminal public key 102D and transmission terminal user information 102E.

When the radio terminals 1B, 1c monitor the response message 102 to the calling message from other terminal and receive the response message 102 from the other terminal, generate the entry including the transmission terminal address 102C and the transmission terminal user information 102E extracted from respective response messages and register the entry in the above-mentioned provisional terminal list 260A. In this manner, each time each radio terminal 1 (1A, 1B, 1C) receives the calling message 101 or the response message 102, the radio terminal 1 updates the provisional terminal list 260A or the terminal list 260B and autonomously prepares constituting terminal list of the new CUG. The contents of the entry registered in the provisional terminal list 260A and the terminal list 260B corresponding to the entry are automatically cancelled when a given time lapses after receiving the calling message.

At a point of time that the initial member confirmation period (T1) has lapsed, the radio terminal 1A which becomes the caller of new CUG, the contents of the entry of the provisional group list 250A on the above-mentioned new CUG and the provisional terminal list 260A corresponding to the entry are moved to the group list 250B and the terminal list 260B respectively.

The radio terminal 1A establishes the P-P connection among respective radio terminals constituting the new CUG. As mentioned previously, in each radio terminal, since the registration of the P-P connection permission is made in the security manager processing portion 23 with respect to the terminal address registered in the terminal list 260B, the radio terminals 1B, 1C approve the establishing request of the P-P connection from the radio terminal 1A. The radio terminal 1A transmits a distributing message 103 which sets a common encryption key used by the new CUG to respective terminals through the P-P connection established between the radio terminals 1B, 1C. The distributing message 103 of the above-mentioned common encryption key includes a message kind code 103A indicative of the distribution of the encryption key, a group identifier 103B and a common encryption key 103C which is encrypted by a public key of a counterpart terminal.

The radio terminals 1B, 1C which receive the above-mentioned distributing message 103 decrypts an encrypted portion 103C of the received message using their respective confidential encryption key and obtain the common encryption key. The radio terminals 1B, 1C register the common encryption key obtained by the decryption to the group list 250B as an encryption key 254B. On the other hand, the radio terminal 1A which becomes a transmission source of the distributing message 103 also registers the common encryption key which the radio terminal 1A per se has transmitted to the group list 250B as an encryption key 254B.

After distributing the common encryption key, the radio terminal 1A generates an encryption key changeover message 104 and transmits this message to the constituting terminals of the new CUG in a multicast manner and moves to the communication phase 11. As shown in FIG. 10, the above-mentioned encryption key changeover message 104 includes a changeover message code 104A and a group identifier 104B encrypted by the common encryption key. Upon receiving the above-mentioned changeover message 104, respective radio terminals 1B, 1C move to the communication phase 11 and perform the group communication while encrypting/decrypting the transmission/reception information using the above-mentioned encryption key.

In the communication phase 11, respective constituting terminals of the CUG communicate with each other by multicasting the user data messages 105. The user data message 105 includes a message kind code 105A indicative of user data, group identifier 105B, a transmission terminal address 105C and user data 105D. Among them, the transmission terminal address 105C and the user data 105D are encrypted by the common encryption key. The information encrypted by the above-mentioned common encryption key can be decrypted only at the CUG constituting terminal having the same common encryption key so that it becomes possible for respective constituting terminals 1 (1A, 1B, 1C) of the CUG to perform the group communication having the high closed characteristics.

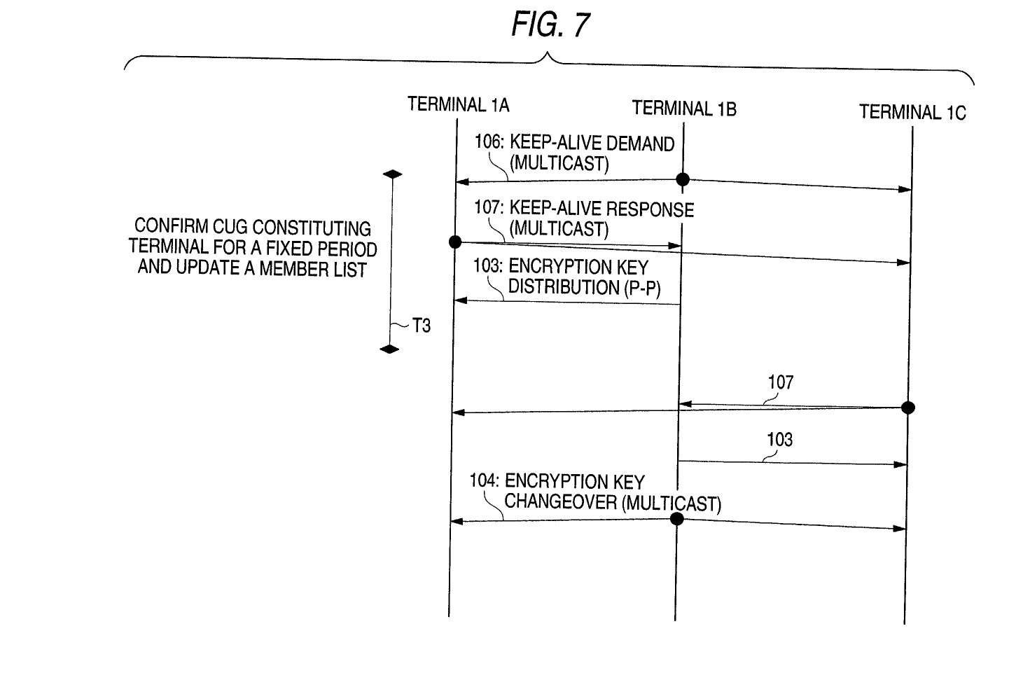

FIG. 7 shows the keep-alive processing sequence in which the radio terminals 1 (1A, 1B, 1C) which perform the group communication periodically confirm the constituting terminals of the CUG in the communication phase 11, and periodically update the terminal list 260B. Respective constituting terminals of the CUG are respectively provided with keep-alive timers (C) and each time the constituting terminal receives the encryption key changeover message 104, the constituting terminal sets a random value in the keep-alive timer (C) and starts its operation. When the time-out of the keep-alive timer is generated, the radio terminal 1B multicasts a keep-alive request message 106 and waits for a response for a fixed time (T3). As shown in FIG. 10, the keep-alive message 106 includes a message kind code 106A indicative of the keep-alive, a group identifier 106B, a transmission terminal address 106C, and transmission terminal user information 106D. Among them, the transmission terminal address 106C and the transmission terminal user information 106D are encrypted by a common encryption key.

The respective radio terminals (1A, 1C) which have received the keep-alive message 106 multicast a continuation message 107 to inform the continuation of the group communication at their own terminals as a keep-alive response. The continuation message 107 includes a message kind code 107A indicative of a continuation message, a group identifier 107B, a transmission terminal address 107C, transmission terminal user information 107D and a public key 107E for transmission terminal, wherein the transmission terminal address 107C, the transmission terminal user information 107D and the public key 107E are encrypted by the common encryption key. The radio terminal 1A, 1C which have received the continuation message 107 from other terminal stop the keep-alive timer (C) of its own terminal.

Respective constituting terminals of the CUG which have received the keep-alive message 106 or the continuation message 107 set an ON flag which indicates that the communication is being continued in the reception state field 264B of an entry corresponding to the transmission terminal of the received message in the terminal list 260B and when the transmission terminal of the received message is not registered in the terminal list 260B, a new entry is additionally registered.

The radio terminal 1B which becomes a transmission source of a keep-alive message 106 establish a P-P connection among respective radio terminals which have returned the continuation message 107 and distributes a new common encryption key through the distributing message 103. Further, at a point of time that a fixed time (T3) has lapsed after transmitting the keep-alive message 106, the radio terminal 1B broadcasts an encryption key changeover message 104. The changeover message 104 includes a message kind code 104A indicative of a changeover message and a group identifier 104B which is encrypted by the new common encryption key. As the group identifier 104B, in place of the conventional identifier, it may be changed to a new group identifier set by the radio terminal 1B.

When the group identifier is changed to a new identifier based on the changeover message 104, the CUG constituting terminals 1 (1A, 1B, 1C) are registered in the group list 250B. At a point of time of transmitting or receiving the changeover message 104, respective constituting terminals of the CUG delete the entry with no ON flag set in the reception state field 264B from the terminal list 260B and continue the communication operation of the CUG after restarting the keep-alive timer (C) with random set values. Due to the delivery of the changeover message 104, respective constituting terminals of the CUG adopt the new common encryption key and use a new group identifier when necessary so as to continue the group communication.

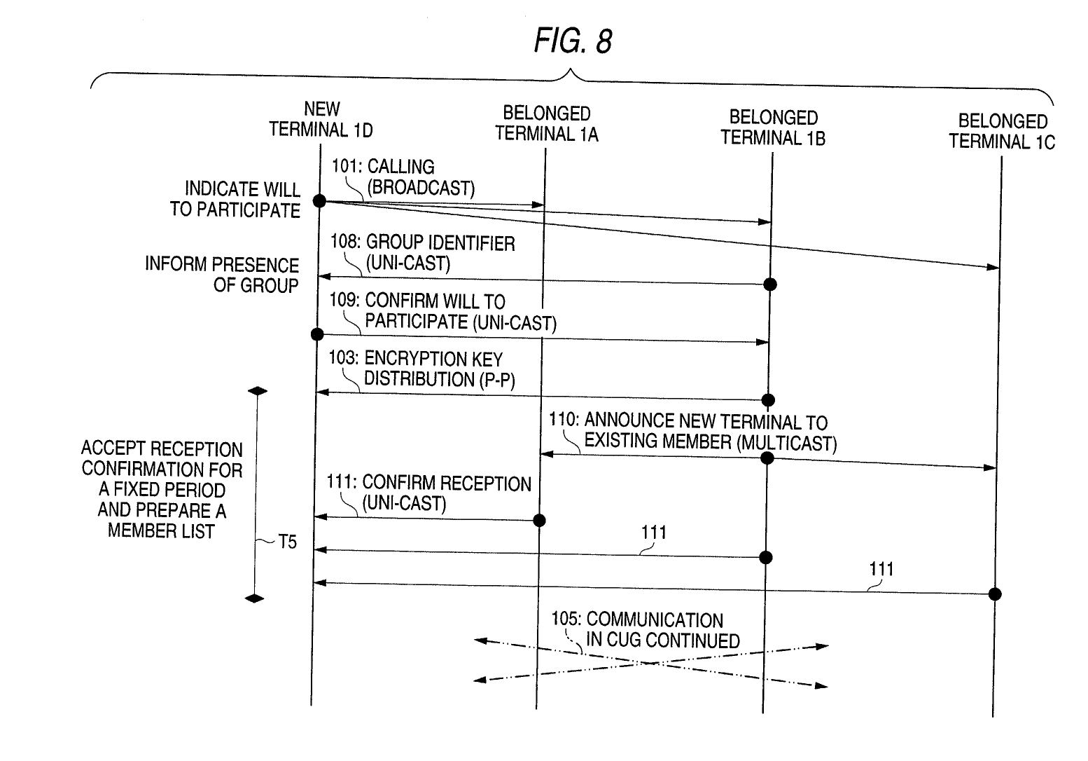

FIG. 8 shows the processing sequence in which a new terminal 1D is added to the closed communication network consisting of the radio terminals 1A, 1B, 1C. These processing are performed at the addition phase 12 with respect to the radio terminals 1A, 1B, 1C and at the new connection phase 10 with respect to the new terminal 1D. The connection processing of the new terminal to the existing CUG differs depending on the state of the open/closed flag 101D of the calling message 101 which is first broadcast at the time of constituting the CUG. Here, the processing sequence when the CUG is opened is shown.

When the user selects the connection input key 41 and selects the new CUG 45 at the new terminal 1D, the new calling message 101 is broadcast to a large number of unspecified radio terminals. When the CUG is opened using the open/closed flag 101D at the time of constituting the CUG, the radio terminals 1A, 1B, 1C which have been already performing the group communication respond to the reception of the new calling message 101 and return the group communication message 108 to the terminal 1D which becomes a transmission source in a unicast manner. As shown in FIG. 11, the group communication message 108 includes a message kind code 108A indicative of a group communication, a destination terminal address (address of terminal 1D) 108B, a group identifier 108C of the CUG which the own terminal belongs to, a transmission terminal address 108D and the group kind 108E of the CUG.

Upon receiving the group communication message 108, the terminal 1D registers a new administration information entry including the group identifier 108C and the group kind 108E extracted from the received message in the provisional group list 250B and thereafter displays the content of the entry on the console device 4. When a plurality of group communication messages having the same group identifier 108C are received, the first received message is kept and succeeding messages are abandoned.

When the user of the terminal 1D selects the group identifier which is indicated by the group communication message 108 and instructs the connection on the console screen, the terminal 1D transmits a participation confirmation message 109 in a unicast manner to a transmission source of the group communication message 108 (here, the radio terminal 1B) and moves the administration information entry including the group identifier from the provisional group list 250A to the group list 250B, and registers the address of the radio terminal 1B to the terminal list 260B.

As shown in FIG. 11, the participation confirmation message 109 includes a message kind code 109A indicative of a participation confirmation message, a designation terminal address (address of the radio terminal 1B) 109B, a group identifier 109C presented in the group communication message 108, a transmission terminal address 109D and the public key 109E of the transmission terminal.

The radio terminal 1B which has received the participation confirmation message 109A establish a P-P connection between the radio terminal 1B and the new radio terminal 1D and transmits the distributing message 103 showing the common encryption key which is being used in the CUG. Further, the radio terminal 1B generates an addition notice message 110 which indicates the address of the new terminal ID and multicasts the message to respective constituting terminals of the CUG. As shown in FIG. 11, the addition notice message 110 includes a message kind code 110A indicative of an addition notice, a group identifier 110B, a new terminal address 110C and new terminal user information 110D, wherein the new terminal address 110C and the new terminal user information 110D are encrypted by the common encryption key.

Upon receiving the distributing message 103, the new terminal 1D registers the common encryption key in the group list 250B and thereafter waits for a reception confirmation message 111 transmitted form respective constituting terminals of the CUG for a fixed time (T5). On the other hand, the radio terminal 1B which becomes the transmission source of the addition notice message 110 and other radio terminals (1A, 1C) of the CUG which have received the addition notice message 110 respectively generate the reception confirmation message 111 and transmits the message to the new terminal 1D in a unicast manner. The reception confirmation message 111 includes a message kind code 111A indicative of the reception confirmation, a destination terminal address (address of the radio terminal ID) 111B, a group identifier 111C, a transmission terminal address 111D and user information 111E of transmission terminal. Among these items, a group identifier 111C, the transmission terminal address 111D and the user information 111E are encrypted by the common encryption key. As the user information 111E, the user name is set, for example. The new terminal 1D registers the transmission terminal address 111D and the user information 111E which are extracted from the received reception confirmation message 111 within a fixed time (T5) in the terminal list 260B and thereafter participates in the group communication as a member of the CUG.

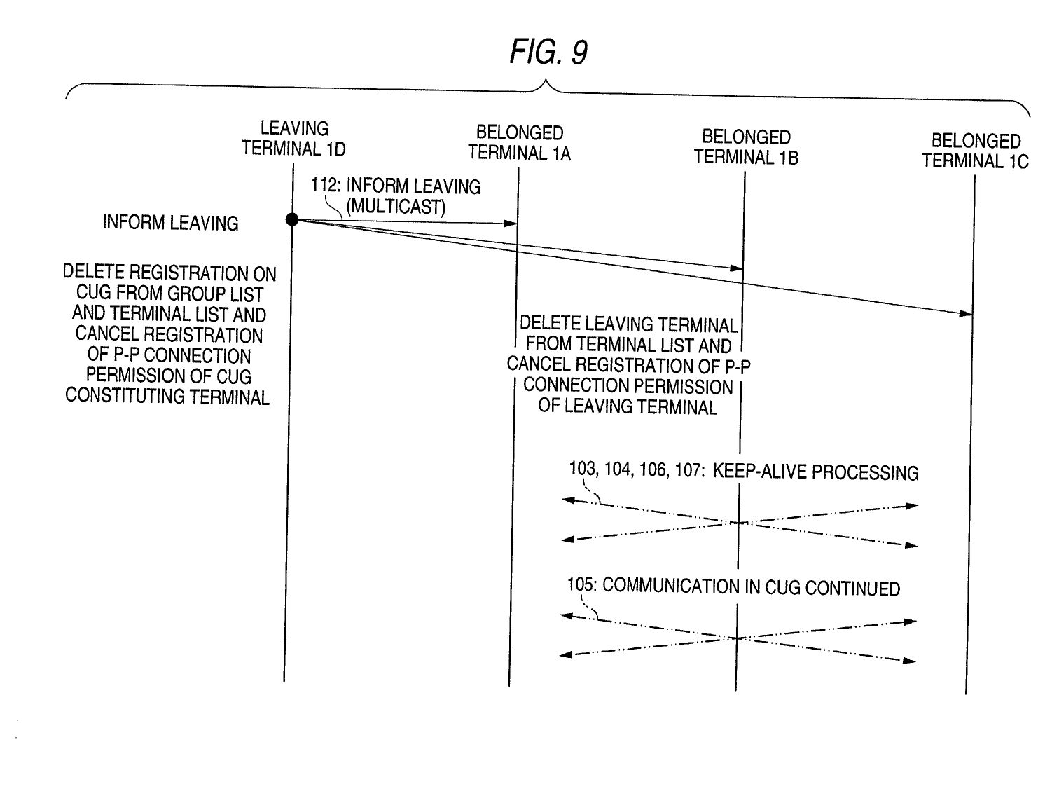

FIG. 9 shows the processing sequence in which the radio terminal 1D which is performing the group communication leaves from the CUG. These processing are executed at the dissolving phase 14 with respect to the leaving terminal 1D and at the leaving phase 13 with respect to other constituting terminals (1A, 1B, 1C) of the CUG. When the user of the leaving terminal 1D selects the leaving input key 42 on the console screen and performs inputting by selecting one of the group identifiers 46 displayed on the screen, the leaving terminal 1D transmits a leaving communication message 112 in a multicast manner to the constituting terminals of the CUG having the selected group identifier, and thereafter deletes the administration information entry having the group identifier from the group list 250B and deletes the terminal list 260B corresponding to the administration information entry. Further, the leaving terminal 1D informs the security manager processing portion 23 of the leaving communication message 112 and cancels the permission of the P-P connection relating to respective constituting terminals of the CUG.

As shown in FIG. 11, the leaving communication message 112 includes a message kind code 112A indicative of the leaving communication, a group identifier 112B and a transmission terminal address 112C. Among these items, the transmission terminal address 112C is encrypted by the common encryption key.

Upon receiving the leaving communication message 112, other constituting terminals (1A, 1B, 1C) of the CUG delete the address of the leaving terminal 1D which the received message indicates from the terminal lists 260B and inform the security manager processing part of the leaving communication message 112 and cancels the P-P connection permission of the leaving terminal 1D. Thereafter, respective constituting terminals restart the keep-alive timers (C) having randomly set values. Accordingly, the radio terminal which has the time-out generated first starts the keep-alive processing and the encryption key used by the CUG is updated.

In respective radio terminals, when the terminal list 260B becomes empty as a result of the fact which is mentioned above, the leaving terminal is deleted from the terminal list 260B or the radio terminal which does not respond in the keep-alive processing is deleted from the terminal list 260B, the administration information entry corresponding to the terminal list is deleted from the group list 250B and the group communication at the corresponding CUG is finished. These processing are executed at the dissolving phase 14.

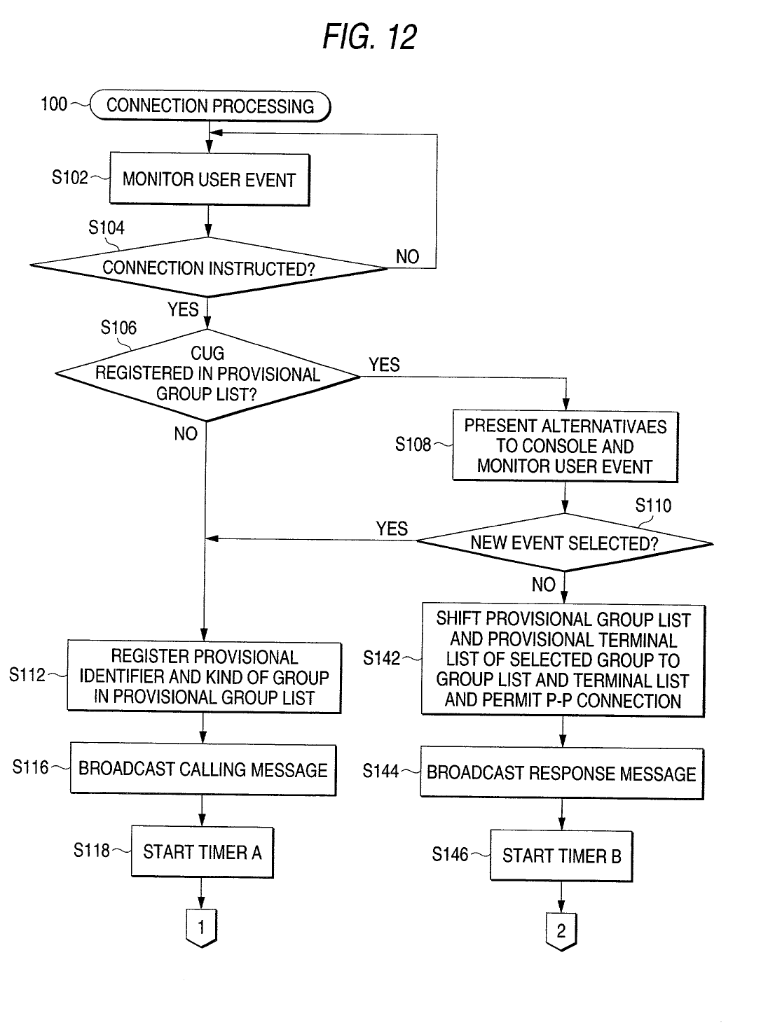

FIG. 12-FIG. 20 show flow charts of programs provided to the connection control processing parts 24 of respective radio terminals 1 for executing the above mentioned processing sequence. FIG. 12 shows a connection processing routine 100 to the closed communication network. In the connection processing routine 100, a user event is monitored (S102). When the user event is generated, it is judged whether the user event is the connection instruction or not (S104). If it is not the connection instruction, the processing returns to the monitoring operation of the user event (S102) and waits for the inputting of the connection instruction. When the user instructs the connection (selects the connection input key 41), it is judged whether the CUG administration information entry is registered in the provisional group list 250A or not (S106). If the entry is registered, the alternatives 44 of the registered CUG and the alternatives 45 of the new CUG are displayed on the console device 4 and the user event is monitored (S108).

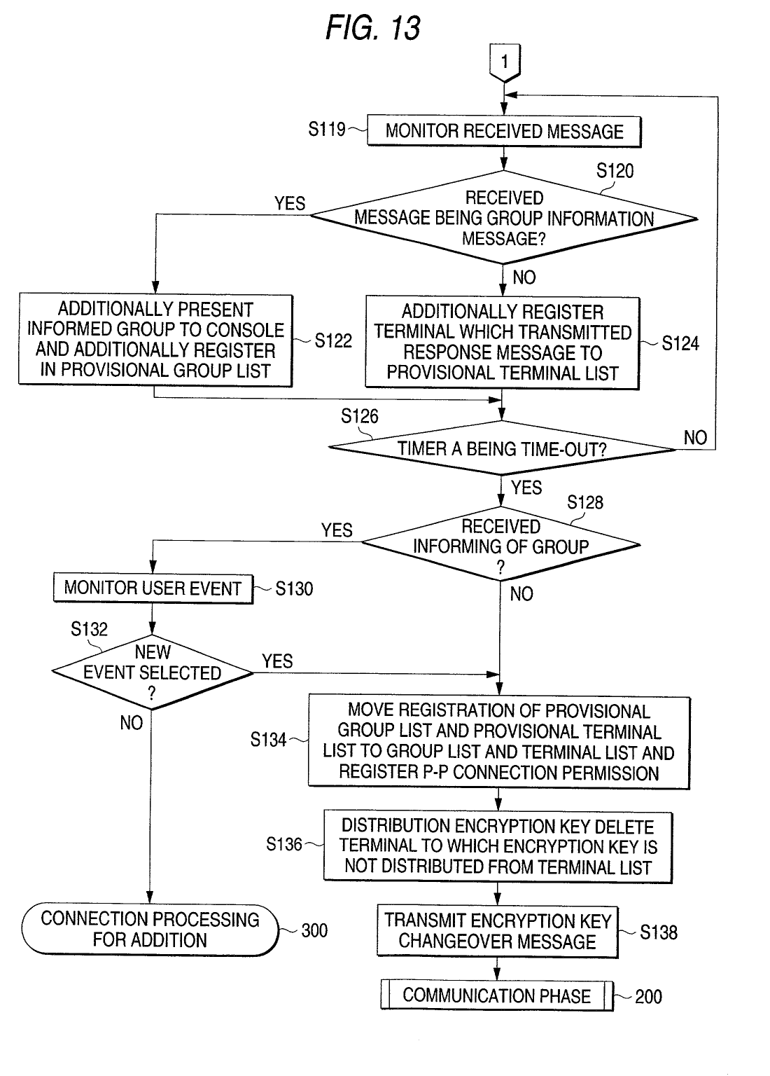

When the user event is generated, it is judged whether the user has selected the new CUG alternatives 45 or not (S110). If the new CUG alternatives 45 are selected, the administration information entry including the provisional group identifier which is automatically generated and the group identifier inputted into the group kind box 51 is registered in the provisional group list 250A (S112). Subsequently, the calling message 101 is generated and is transmitted by broadcasting (S116). Thereafter the timer A is started (S118) and the received message from other terminals is monitored for a fixed time (T1) in step S119 shown in FIG. 13.

Upon receiving the message from other terminals, it is judged whether received message is the group communication message 108 or not (S120). If the received message is the group communication message, the group identifier and the group kind are displayed on the console screen and at the same time the entry including the group identifier and the group kind is registered in the provisional group list 250A (S122). If the received message is the response message 102, the entry including the transmission terminal address and the user information indicated by the response message 102 is registered in the provisional terminal list 260A (S124).

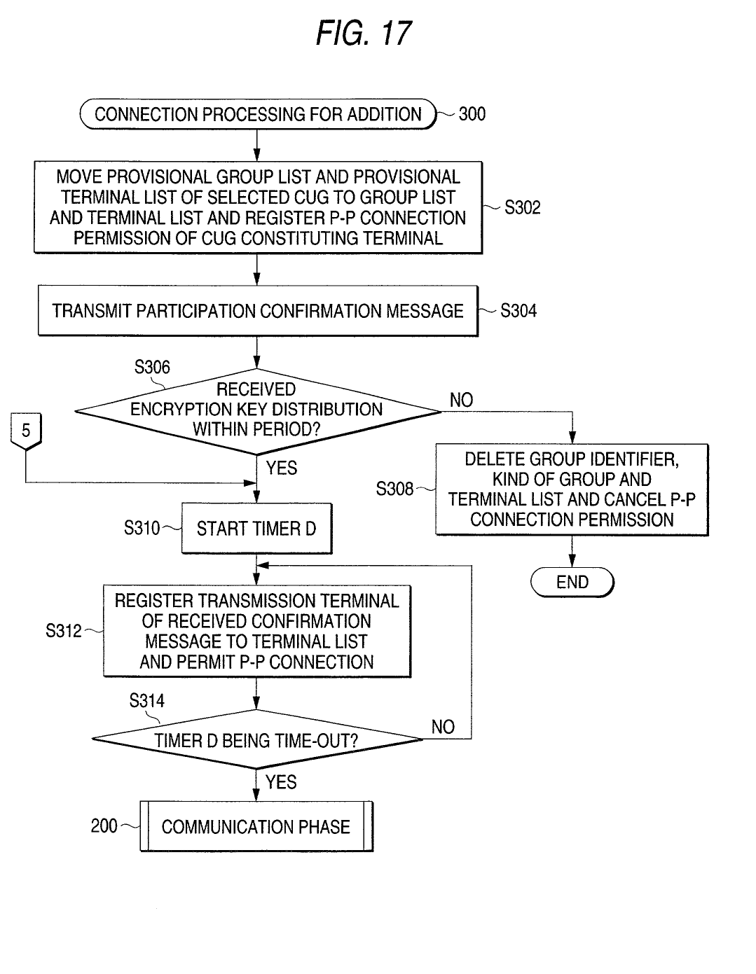

The above-mentioned steps 119-124 are repeated until the time-out of the timer A is generated. When the time-out of the timer A is generated (S126), it is judged whether the group communication message 108 is received or not (S128). If the group communication message 108 is received, the user event is monitored (S130) and it is judged whether the new CUG alternatives 45 are selected or not (S132). If the user selects the new CUG alternatives 45, the processing advances to step S134, while if the CUG alternatives 44 is selected, the connection processing for addition (300) which will be explained later in conjunction with FIG. 17 is executed.

When the group communication message 108 is not received or when the user selects the new CUG alternatives 45, to perform the group communication in the new CUG, the content of the entry registered in the provisional group list 250A in step S112 is moved to the group list 250B and the content of the provisional terminal list 260A corresponding to the provisional group list 250A is moved to the terminal list 260B, and the addresses of respective radio terminals registered in the terminal list 260B are registered in the security manager processing portion 23 as the connection permission registration (S134). Subsequently, the P-P connection is established among respective radio terminals which are registered as the connection permission registration and the encryption key is distributed along with the distributing message 103 (S136). If there exists the terminal to which the encryption key cannot be delivered, the administration information entry on the terminal is deleted from the terminal list 260B. Thereafter, the encryption key changeover message 104 is generated and is transmitted to respective constituting terminals of the CUG in a multicast manner (S138) and the processing advances to the communication phase 200. The terminal 1A explained in view of FIG. 1 executes the above-mentioned processing sequence.

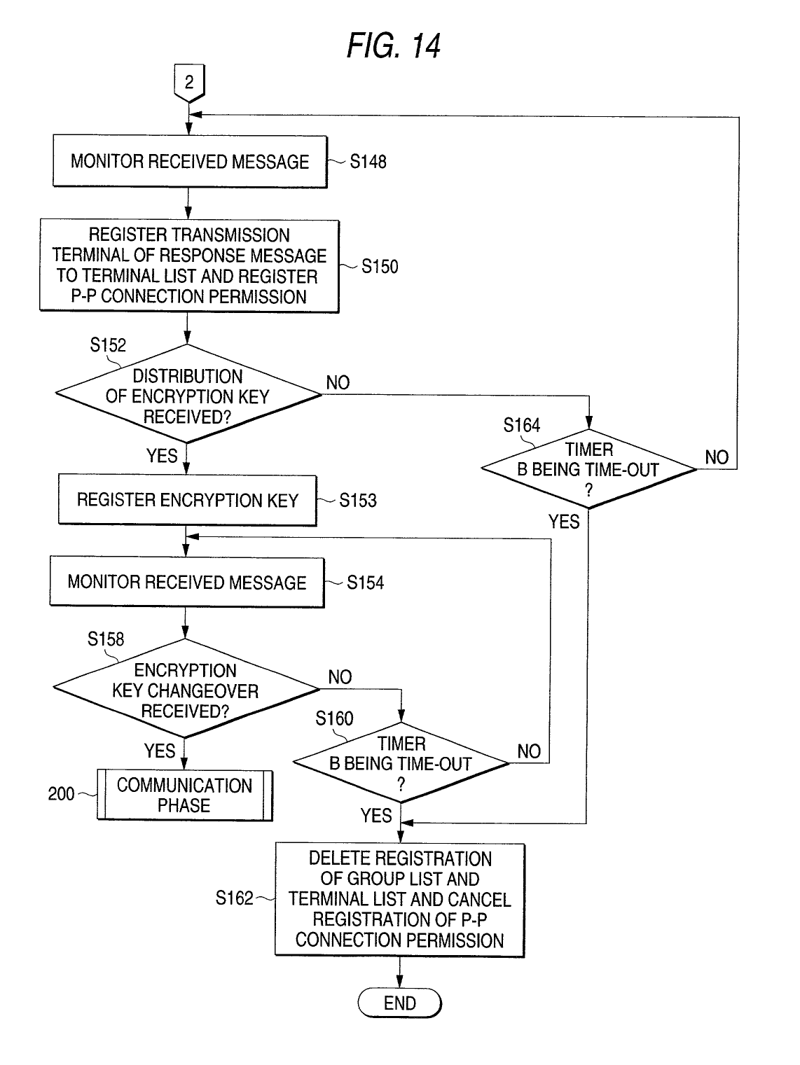

Returning to FIG. 12, when the user selects alternatives other than the new CUG alternatives 45 in step S110, that is, when the user selects the CUG alternatives registered in the provisional group list, the administration information entry indicated by the CUG alternatives present in the provisional group list 250A are moved to the group list 250B, the content of the provisional terminal list 260A corresponding to the administration information entry is moved to the terminal list 260B, and the terminal address registered in the terminal list 260B are registered in the security manager 23 in the connection permission registration (S142). Subsequently, the response message 102 is generated and is transmitted by broadcasting (S144). Then, the timer B is started and the received message from other terminal is monitored for a fixed time (T2) in step S148 in FIG. 14.

When the received message from the other terminal is the response message 102, the transmission terminal address and the user information of the response message are registered in the terminal list 260B and, with respect to the transmission terminal address, the P-P connection permission is registered in the security manager processing portion 23 (S150). Subsequently, it is judged whether the received message is the distributing message 103 of the encryption key or not (S152). If the received message is not the distributing message 103 of the encryption key, it is judged whether the time-out of the timer B is generated or not (S164). If the time-out of the timer B is not generated, the processing returns to the step S148 and the monitoring of the received message is further continued. When the time-out of the timer B is generated without receiving the distributing message of the encryption key, the entry registered this time is deleted from the group list 250B and the terminal list 260B corresponding to the entry key is cancelled and, with respect to the terminal address registered in the terminal list, the connection permission in the security manager processing portion 23 is cancelled (S162) and the connection processing is finished.

In step S152, when the received message is the distributing message 103 of the encryption message, the encryption key extracted from the received message is registered in the group list 250B (S153) and thereafter the next received message is monitored (S154). When the message is received, it is judged whether the received message is the encryption key changeover message 104 or not (S158). If the changeover message 104 is received, the processing advances to the communication phase 200. If the received message is not the changeover message 104, it is judged whether the time-out of the timer B is generated or not (S160). If the time-out of the timer B is not generated, the monitoring of the received message is continued in step S154. If the time-out of the timer B is generated, the processing advances to step 162 where the deletion of the entry from the group list 250B, the canceling of the terminal list 260B and the canceling processing of the connection permission of the terminal address in the security manager processing portion 23 are executed and thereafter the connection processing is finished. The above-mentioned processing correspond to the operation in the terminals 1B, 1C explained in conjunction with FIG. 1.

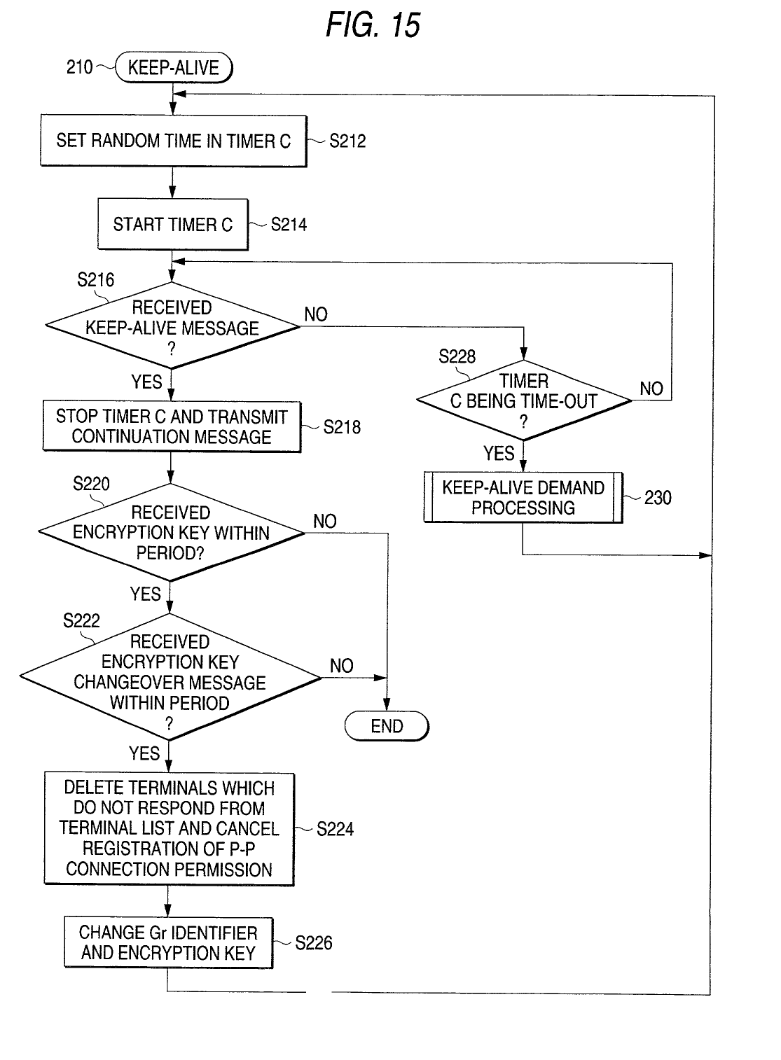

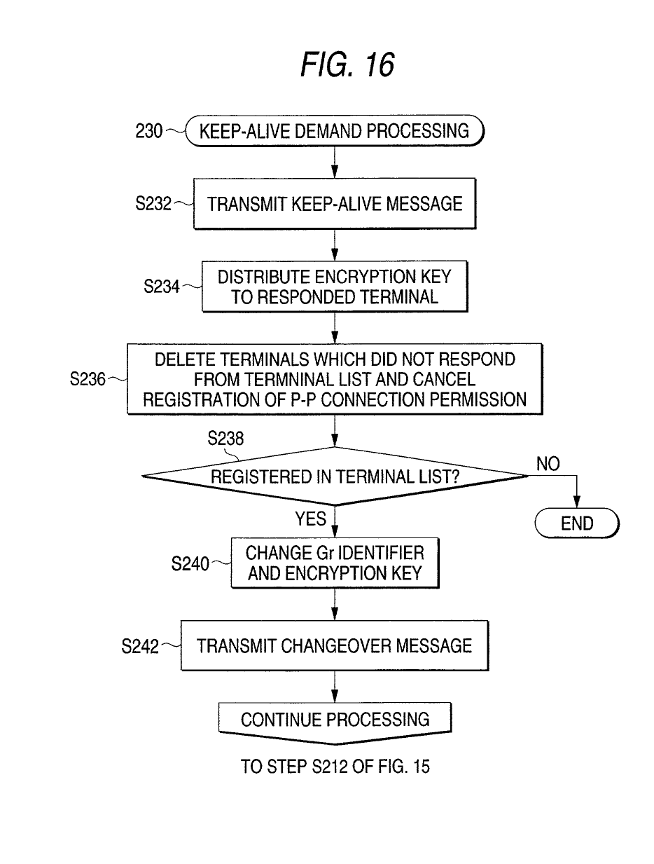

FIG. 15 shows a flow chart of the keep-alive processing routine S210. In keep-alive processing S210, a random time is set in the keep-alive timer (C) (S212) and then the timer is started (S214). Then, the processing waits for the reception of the keep-alive message (S216). When the keep-alive message is received, the keep-alive timer (C) is stopped and the continuation message 107 is transmitted to the constituting terminals of the CUG in a multicast manner (S218). Thereafter, the processing waits for the reception of the distributing message 103 of the encryption key (S220). If the distributing message 103 of the encryption key is not received within a fixed time, the keep-alive processing is finished.

When the distributing message 103 of the encryption key is received within the fixed time, the processing waits for the reception of the encryption key changeover message 104 (S222). When the changeover message 104 is not received, the keep-alive processing is finished. When the changeover message 104 is received within a fixed time, the administration information entry of the terminal which does not multicast the continuation message 107 in response to the keep-alive message 106 is deleted from the terminal list 260B and the P-P connection permission registration by the security manager processing portion 23 with respect to the above-mentioned terminal is cancelled (S224). After registering the new encryption key and the group identifier indicated by the above-mentioned encryption key distributing message 103 in the group list 250B (S226), the processing returns to step S212. The above-mentioned processing corresponds to the operation of the radio terminals 1A, 1C explained in conjunction with FIG. 7.

The waiting of the keep-alive message 106 in step S216 is repeated until the time-out of the keep-alive timer (C) is generated (S228). When the time-out of the keep-alive timer (C) is generated, the processing returns to step S212 after executing the keep-alive request processing 230.

FIG. 16 shows the detailed flow chart of the keep-alive request processing 230. In the keep-alive request processing 230, the keep-alive message 106 is transmitted in a multicast manner (S232) and the encryption key is distributed to the terminals which have returned the continuation message 107 in response to the keep-alive message 106 by the encryption key distribution message 103 (S234). With respect to the terminal which does not respond to the keep-alive message 106 within a fixed time, the administration information entry is deleted from the terminal list 260 and the P-P connection permission in the security manager processing portion 23 is canceled (S236).

Subsequently, the registration entry in the terminal list 260B is checked (S238). When the registration entry in the terminal list 260 is present, the group identifier and the encryption key are registered in the group list 250B (S240), and the changeover message 104 is transmitted in a multicast manner to the constituting terminals of the CUG registered in the terminal list 260B (S242) and the processing advances to step S212 of FIG. 15. When the entry is not registered in the terminal list 260B in step S238, the keep-alive processing 210 is finished. The above-mentioned processing corresponds to the operation of the radio terminal 1B explained in conjunction with FIG. 7.

FIG. 17 is a flow chart showing the connection processing for addition routine 300 to the closed communication network. In the connection processing for addition routine 300, the administration information entry of the CUG selected by the user in the step S132 of FIG. 13 is moved from the provisional group list 250A to the group list 250B, the provisional terminal list 260A corresponding to the above-mentioned CUG is moved to the terminal list 260B, and the P-P connection permission is registered in the security manager processing portion 23 with respect to the terminal address registered in the terminal list (S302). Subsequently, the participation confirmation message 109 is generated and this is returned to the radio terminal which becomes a transmission source of the group communication message (S304). Then, the processing waits for the reception of the distributing message 103 of the encryption key (S306). When the distributing message 103 of the encryption key is not received within a fixed time (T4), the administration information entry registered this time is deleted from the group list 250B and the terminal list 260B corresponding to the administration information entry is deleted and the P-P connection permission by the security manager processing portion 23 with respect to the constituting terminals of the CUG indicated by the terminal list 260 is cancelled (S308) and thereafter the connection processing is finished.

When the distributing message 103 of the encryption key is received within a fixed time (T4), the timer D is started (S310) and the received message is monitored. When the reception confirmation message 111 is received, the entry including the transmission terminal address of the received message and the user name indicated as the user information is registered in the terminal list 260B and the P-P connection permission is registered in the security manager processing portion 23 with respect to the above-mentioned terminal address (S312). The reception processing of the above-mentioned reception confirmation message 111 is repeated until the time-out of the timer D is not generated. When the timer D becomes timeout (S314), the processing advances to the communication phase 200. The above-mentioned processing corresponds to the operation of the new terminal 1D explained in conjunction with the FIG. 8.

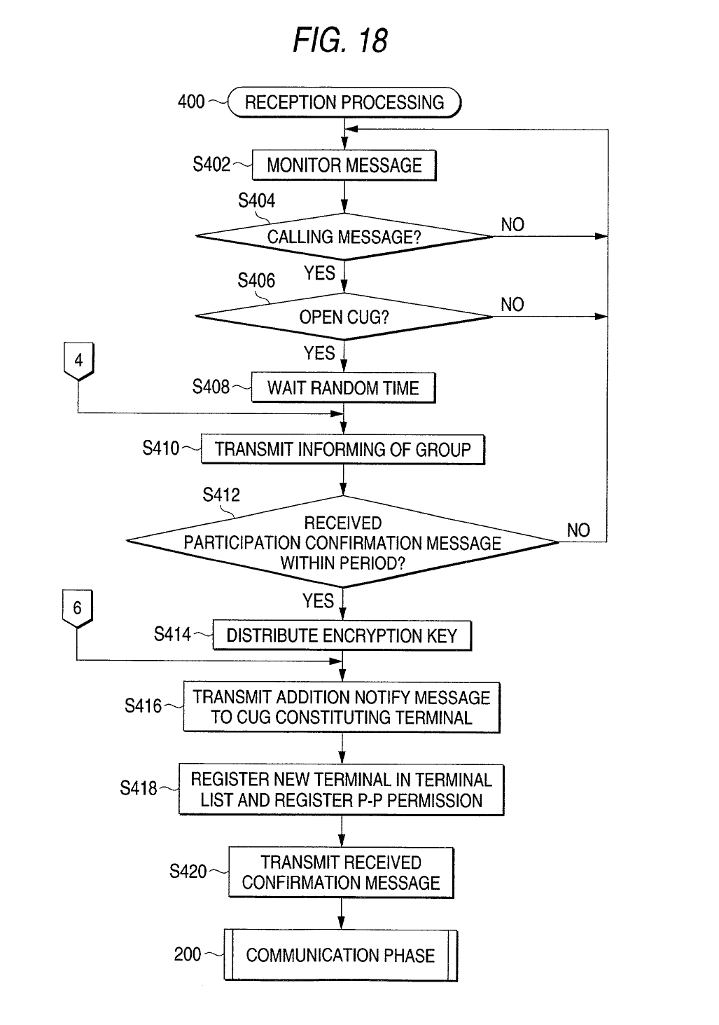

FIG. 18 shows a flow chart of the reception processing routine 400 executed by the radio terminal at the side which accepts a new terminal to the CUG. In the reception processing routine 400, the received message is monitored (S402). When the message is received, it is judged whether the received message is the calling message 101 or not (S404). When the received message is not the calling message 101, the processing returns to step S402 and continues the monitoring of the received message. When the calling message 101 is received, it is judged whether the CUG in which the own terminal participates is opened or not (S406). When the CUG is closed, the processing returns to step S402. When the CUG is opened, after a randomly set time elapses (S408), the group communication message 108 is transmitted to the new terminal which becomes the transmission source of the calling message 101 (S410) and the processing waits for the reception of the participation confirmation message 109 from the above-mentioned terminal (S412).

When the participation confirmation message 109 is received, the P-P connection is established to the new terminal and the encryption key to be used in the CUG is distributed by the encryption key distribution message 103 (S414). Subsequently, the address of the new terminal is informed to the constituting terminals of the CUG by the addition notice message 110 (S416), the administration information entry of the new terminal is registered in the terminal list 260B, and the connection permission is registered in the security manager processing portion 23 with respect to the new terminal address (S418). Thereafter, the reception confirmation message 111 is transmitted to the new terminal (S420) and the processing advances to the communication phase 200. The above-mentioned processing corresponds to the operation of the terminal 1B explained in conjunction with FIG. 8.

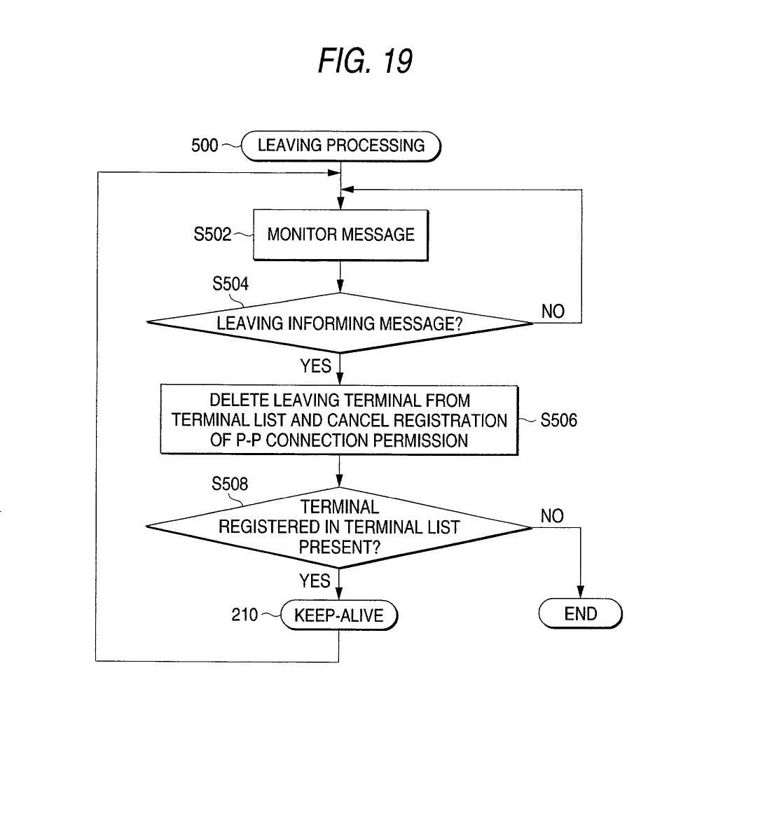

FIG. 19 shows a flow chart of the leaving processing routine 500. In the leaving processing routine 500, the received message is monitored (S502). Then, the processing waits for the reception of the leaving communication message 112 (S504). When the leaving communication message 112 is received, the administration information entry of a transmission source terminal of the leaving communication message is deleted from the terminal list 260B and the connection permission by the security manager processing portion 23 with respect to the address of the terminal is cancelled (S506). The number of entries remaining in the terminal list 260B is checked (S508). When the registered terminals are present in the terminal list, the keep-alive processing is executed and thereafter the processing returns to step S502 so as to continue the monitoring of the received message. When the number of terminals registered in the terminal list 260B becomes zero as the result of deleting the entry of the leaving terminals, the CUG administration information entries corresponding to the terminal list 260B are deleted from the group list 250B and the processing is finished. The above-mentioned processing corresponds to the operation of the terminals 1A, 1B, 1C explained in conjunction with FIG. 9.

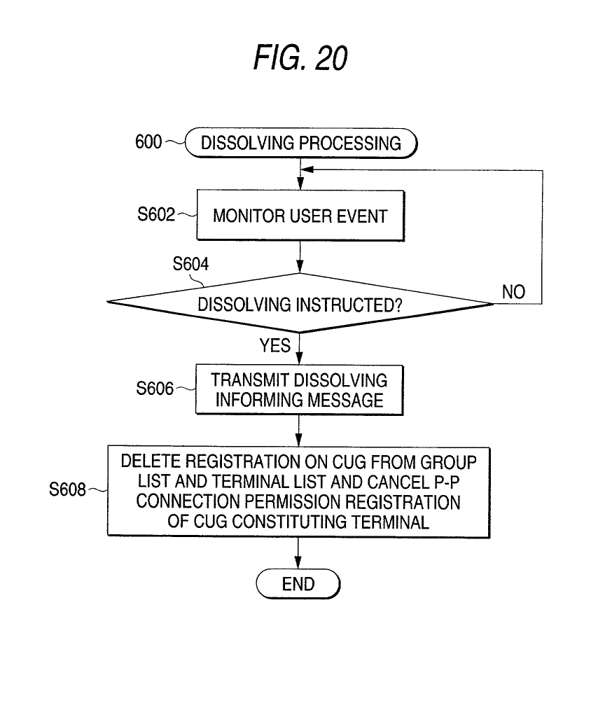

FIG. 20 is a flow chart of the dissolving processing routine executed at the radio terminal left from the closed communication network. In the dissolving processing routine 600, the user event is monitored (S602) and the processing waits for the inputting of the leaving instruction by the manipulation of the leaving input key 43 (S604). When the leaving instruction is inputted, the user transmits the leaving communication message 112 in a multicast manner to the constituting terminals of the CUG which the user selects on the menu screen (S606). Subsequently, the administration information entry of the leaving CUG is deleted from the group list 250B, the terminal list 260B corresponding to the administration information entry is deleted, and the connection permission in the security manager processing portion 23 with respect to the terminal address registered in the terminal list 260B is cancelled (S608) thus finishing the processing. The above-mentioned processing corresponding to the operation of the leaving terminal 1D explained in conjunction with FIG. 9.

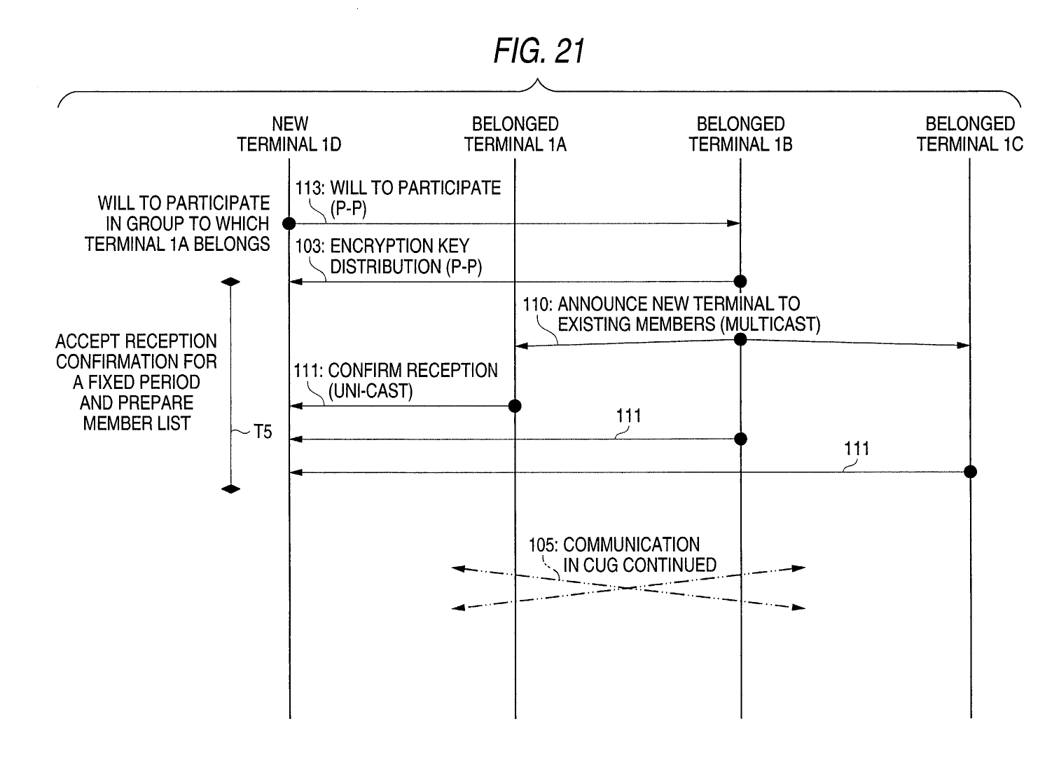

FIG. 21 shows another example of the connection processing for addition wherein the processing sequence for making the new terminal 1D participate in the closed CUG which has been already performing the group communication. In this embodiment, as a condition for making the new terminal 1D participate in the closed CUG at the later stage, it is assumed that the user of the new terminal 1D knows at least one terminal address among a group of terminals constituting the CUG and the will to participate is informed to the terminals. Here, the user of the new terminal 1D knows the address of the radio terminal 1B and FIG. 21 shows the processing sequence in which the additional participation is requested to the radio terminal 1B which has been performing the group communication.

The new terminal 1D establishes the P-P connection between the new terminal and the existing radio terminal 1B and transmits a participation will message 113. As shown in FIG. 11, the participation will message 113 includes a message kind code 113A indicating the participation will, a transmission terminal address 113B, an public key 113C at the transmission terminal and user information 113D indicating a user name, for example. Upon receiving the participation will message 113, the radio terminal 1B distributes an encryption key which is currently used in the CUG to the new terminal 1D by the distributing message 103. Processing which succeeds this processing are equal to those shown in FIG. 8.

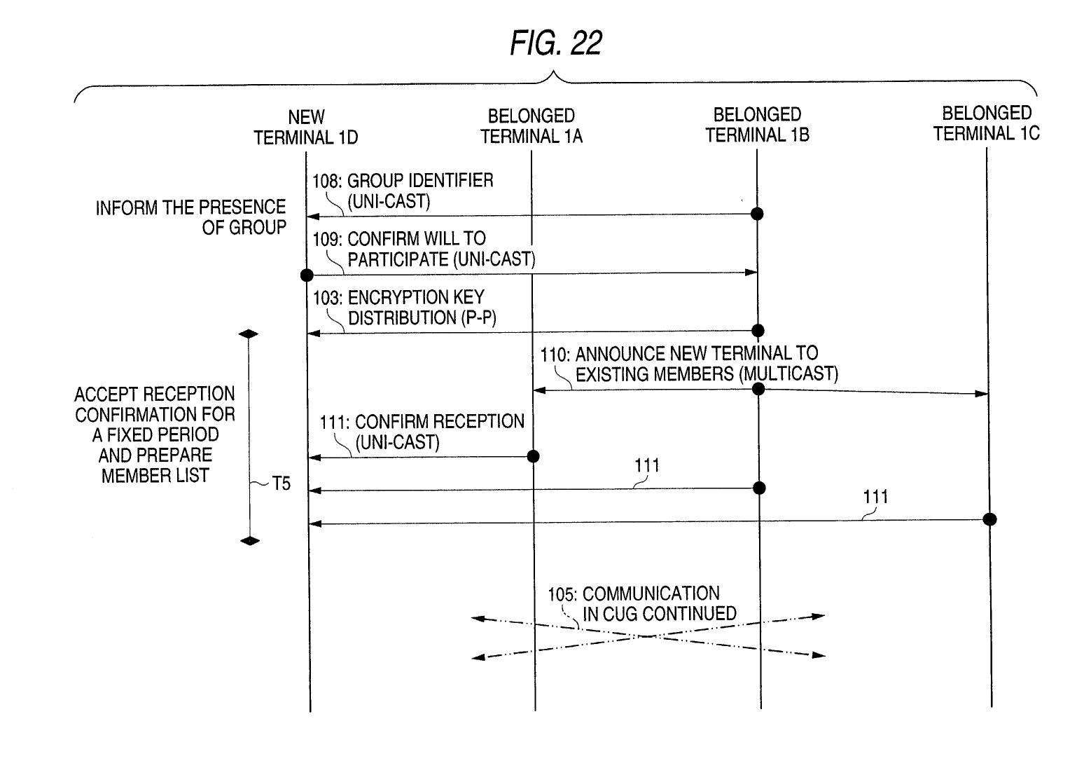

FIG. 22 shows a still another example of the connection processing for addition and shows a processing sequence in which the participation is called from the constituting terminal side of the CUG to the new terminal 1D and the new terminal 1D additionally participates in the CUG in response to the calling. When the user of the radio terminal 1B which participates in the CUG and is performing the group communication inputs an addition input key 43 on the console screen and the address of the new terminal ID is inputted into the terminal address input box 47, a group communication message 108 is transmitted from the radio terminal 1B to the new terminal 1D.

Upon receiving the group communication message 108, the new terminal 1D displays the group identifier and the group kind informed by the group communication message 108 on the console screen. When the user of the new terminal 1D selects the connection input key 41 and selects the group identifier, a participation confirmation message 109 is transmitted from the new terminal 1D to the radio terminal 1B and thereafter the processing sequence equal to the processing shown in FIG. 8 is executed.

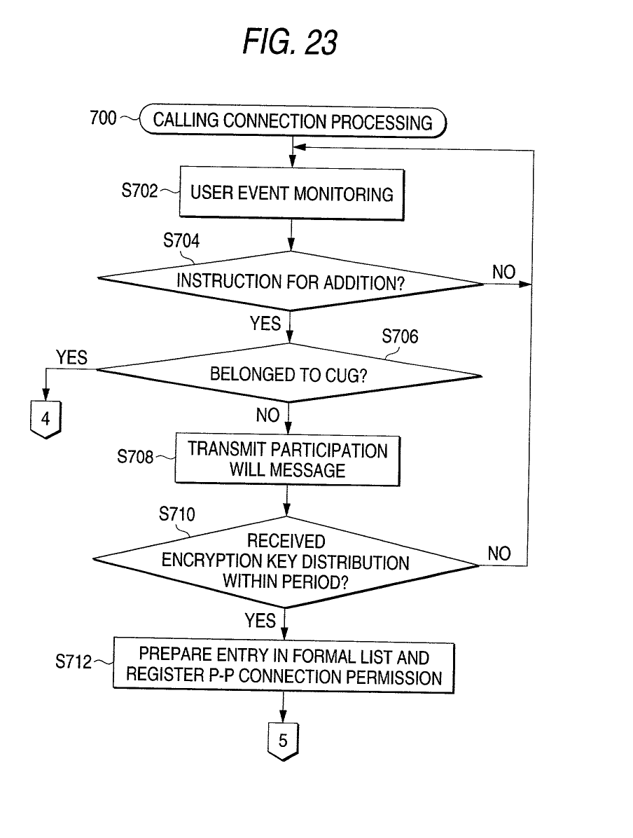

FIG. 23 shows a flow chart of a calling connection processing routine 700 for realizing the above-mentioned addition connection shown in FIG. 21 and FIG. 22. In the calling connection processing routine 700, the user event is monitored (S702) and the processing waits for an instruction for addition (S702). When the user selects the addition input key 43 on the console screen and inputs the radio terminal address which becomes destination to the address input box 47, it is judged whether the own terminal currently belongs to the CUG or not by reference to the group list 250B (S706). When the own terminal belongs to the CUG, the processing in step S 410 and processing in steps which follow step S410 in the reception processing routine shown in FIG. 18 are executed. The operation of the terminal 1B explained in conjunction with FIG. 22 is executed in accordance with the above-mentioned processing sequence.

When the own terminal currently does not belong to the CUG, the P-P connection is established between the own terminal and the radio terminal address inputted to the address input box 47 and the participation will message 113 is transmitted (S708). Subsequently, the processing waits for the reception of the encryption key distributing message 103 (S710). When the encryption distributing message 103 is received, the administration information entry which includes the group identifier of the CUG informed by the message and the encryption key is registered in the group list 250B, terminal address which becomes the destination of the participation will message 113 is registered in the terminal list 260B which corresponds to the administration information entry, and the connection permission is registered in the security manager processing portion 23 with respect to the terminal address (S712). Thereafter, the processing of step S310 and steps which follow step S310 of the connection processing for addition routine shown in FIG. 17 are executed. The operation of the new terminal 1D explained in conjunction with FIG. 21 is executed in accordance with the above-mentioned processing sequence.

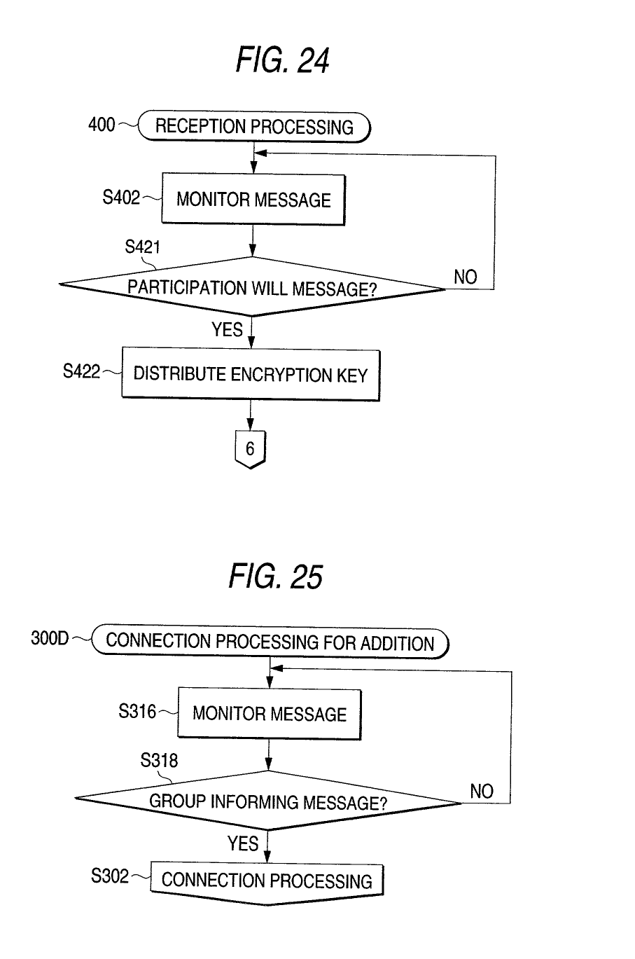

FIG. 24 shows another embodiment of the reception processing routine 400. In the reception processing routine 400, the received message is monitored (S402) and the processing waits for the reception of the participation will message 113 (S 421). When the participation will message 113 is received, the encryption distributing message 103 is transmitted to a transmission source terminal of the message (S422) and then the processing of step S416 and steps which follow step S416 of the reception processing routine shown in FIG. 18 are executed. The operation of the terminal 1B explained in conjunction with FIG. 21 is executed in accordance with the above-mentioned processing sequence.

FIG. 25 shows another embodiment of the connection processing for addition routine 300D. In the connection processing for addition routine 300D, the received message is monitored (S316) and the processing waits for the reception of the group communication message 108 (S318). When the group communication message 108 is received, the processing of step S302 and steps which follow step S302 of the connection processing for addition routine shown in FIG. 17 are executed. The operation of the new terminal 1D explained in conjunction with FIG. 22 is executed in accordance with the above-mentioned processing sequence.

In the above-mentioned embodiments, an example in which the constituting terminals of the CUG perform communication of user information and control information among them by transmitting messages in a multicast manner or in a unicast manner using broadcast channels. However, in place of the multicast transmission, a P-M (Point-to-Multipoint) connection which is set among the constituting terminals of the CUG may be used. Also, in place of the unicast transmission, a P-P connection which is established among the constituting terminals of the CUG may be used. When the P-M connection and the P-P connection are used, each radio terminal can restrict the message transmission counterparts by selectively setting the connection with other radio terminals constituting the CUG.

For example, on the menu screen of the group list shown in FIG. 6, a transmission destination selection field is prepared in addition to a reception selection field 56, and a connection is not set to a terminal which is not provided with a check mark in the transmission destination selection field.

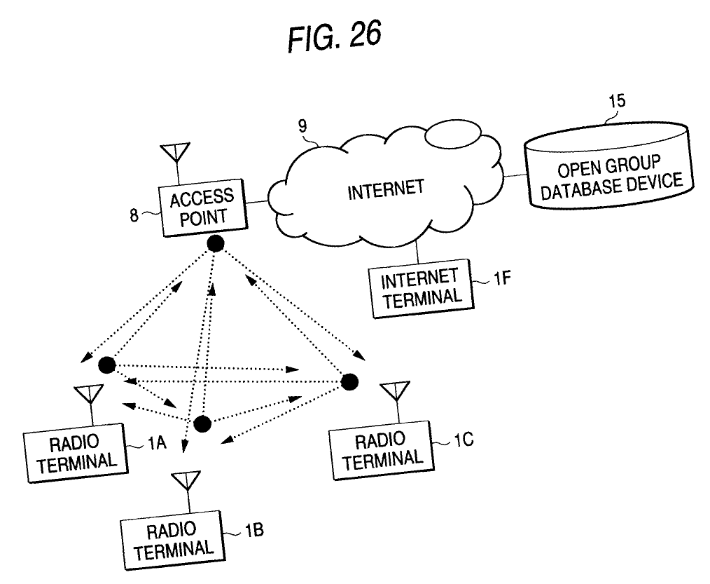

FIG. 26 shows a network constitution which connects an Internet terminal 1F to the CUG including the radio terminals 1A, 1B, 1C which are performing the group communication through an IP network 9 such as Internet or the like and access points 8. Since the message cannot be broadcast to a large number of unspecified terminals on the IP network, the Internet terminal 1F cannot broadcast the calling message 101 for connection with the existing CUG. In such a case, to enable the reception of the connection from the Internet terminal, the address of the terminal which represents the CUG is registered to an open group database 15 on the Internet together with a group identifier and a group kind, the internet terminal 1F selects the CUG in which the internet terminal 1F wishes to participate by reference to the open group database 15, and the participation will message 113 is transmitted to the address of the representative terminal of the selected CUG. By making the representative terminal correspond to the terminal 1B and the Internet terminal 1F correspond to the new terminal 1D, it becomes possible to make the Internet terminal 1F participate in the existing CUG in accordance with the processing sequence shown in FIG. 21.

According to the present invention, the arbitrary terminal calls the forming of the group by broadcasting group identification information to a large number of unspecified terminals and the closed communication network is constituted by the calling terminal and the terminals which respond to the calling whereby the group communication among a plurality of terminals can be realized by using the group identifier (group address).

According to the present invention, by allowing the addition and the leaving of the terminal from the closed communication network which is originally formed, the size of the closed communication network can be flexibly changed and when the encryption communication is applied to the communication within the closed communication network, the exchange of information having the high confidentiality can be performed:

The specification and drawings are, accordingly, to be regarded in an illustrative rather than a restrictive sense. It will, however, be evident that various modifications and changes may be made thereto without departing from the broader spirit and scope of the invention as set forth in the claims.

What we claim is

1. A group communication method in which a plurality of communication terminals form a closed communication network and perform communication, said group communication method comprising
a step in which a calling message including group identification information is broadcast from a first communication terminal to a large number of unspecified communication terminals, and
a step in which the first communication terminal receives response messages broadcast from other communication terminals and including the group identification information,
wherein the closed communication network is formed of the first communication terminal and at least one communication terminal which transmits the response message within a given time after the calling message is transmitted, and
a group communication is performed by the communication message using the group identification information.

2. A group communication method according to claim 1, wherein the group communication method includes a step in which the first communication terminal stores an address of the transmission source terminal of the response message received within a given time after transmitting the calling message as a group constituting terminal corresponding to the group identifier, and a step in which a control message indicative of the start of the group communication is transmitted to the group constituting terminal from the first communication terminal.

3. A group communication method according to claim 2, wherein the group communication method includes a step in which, before the transmission of the control message indicative of the start of the group communication, an encryption key to be used in the group communication is informed from the first communication terminal to the group constituting terminal.

4. A group communication method according to claim 3, wherein the response message includes an public key of a transmission source terminal, and the first communication terminal informs transmission source terminals of respective response messages by encrypting an encryption key to be used in the group communication by the public key.

5. A group communication method according to claim 3, wherein the group communication method further includes a step in which respective group constituting terminals including the first communication terminal respectively measure an encryption key change timing at random and when time reaches the encryption key change timing before receiving a keep-alive message from other terminal, the keep-alive message including the group identifier is broadcast, a step in which the terminal which becomes a transmission source of the keep-alive message informs a transmission source terminal of the response message to the keep-alive message of a new encryption key, and a step in which the terminal which becomes transmission source of the keep-alive message transmits a control message which indicates the start of the group communication after the lapse of a given time from the transmission of the keep-alive message, wherein the encryption key to be used in the group communication is changed over in response to the transmission of the control message.

6. A group communication method which performs communication by forming a closed communication network with a plurality of communication terminals, the group communication method comprising a step in which a calling message for forming the group broadcast from other communication terminals is received, a step in which a communication terminal which has a will to participate in the group broadcasts a response message including group identification information which the calling message indicates, and a step in which the calling message received from other communication terminal and a terminal address which indicates a transmission source of the response message are stored as an address of a group constituting terminal corresponding to the group identifier, wherein a closed communication network is formed of the communication terminal which becomes the transmission source of the calling message and at least one communication terminal which transmits the response message within a given time after the transmission of the calling message, and group communication is performed by the communication message using the group identification information.

7. A group communication method according to claim 6, wherein the communication terminal which receives the calling message for forming the group from other communication terminal displays group kind information indicated by the calling message on a display screen and broadcasts the response message in response to an input manipulation indicating the participation of a terminal user to the group.

8. A group communication method according to claim 2, wherein when the communication terminal receives a communication message indicating the leaving from the group from other communication terminal, the transmission source terminal of the message is excluded from the group constituting terminals and when a state in which no group constituting terminals except for the own terminal are present, the group communication is finished.

9. A group communication method according to claim 1, wherein the calling message includes information whether group communication is to be opened or not, and when the group communication is opened, a control procedure necessary for adding a group constituting terminal between the constituting terminal of the closed communication network formed in an initial state and a newly participating communicating terminal is executed.

10. A communication terminal equipment which performs a group communication with other communication terminals comprising
a transmission/reception circuit for transmitting and receiving a communication message,
a display device,
an input device manipulated by a user,
a storage part which stores a connection control program for controlling a transmission/reception of the communication message, and
a processor which executes the connection control program, wherein
the processor broadcasts the calling message including group identification information to a large number of unspecified communication terminals in response to an user input from the input device, stores an address of the transmission terminals of the response message including the identification information received by the transmission/reception circuit, forms a group between the communication terminal equipment and the transmission terminal of the response message received within a given time after transmitting the calling message, and performs a control operation such that the group communication is performed using the group identification information.

11. A communication terminal equipment according to claim 10, wherein when the calling message from other terminal equipment is received by the transmission/reception circuit, the processor displays group kind information included in the calling message on the display device and broadcasts a response message including the group identification information in response to user input from the input device.
